(19) United States
(12) Patent Application Publication
(10) Pub. No.: US 2026/0274720 A1
(43) Pub. Date: Sep. 17, 2026

(54) PROCESS FOR THE DEGRADATION OF PER- AND POLYFLUORINATED SUBSTANCES (PFAS) USING CATALYTIC OZONOLYSIS

(71) Applicant: THE BOARD OF TRUSTEES OF THE UNIVERSITY OF ALABAMA, Tuscaloosa, AL (US)

(72) Inventors: James William SHOGREN-HARRIS, Tuscaloosa, AL (US); Steven Thomas WEINMAN, Tuscaloosa, AL (US); Alexander P. MINNE, Tuscaloosa, AL (US); Britney D. MACK, Tuscaloosa, AL (US)

(21) Appl. No.: 19/078,599

(22) Filed: Mar. 13, 2025

(51) Int. Cl. C02F 1/72; B01D 61/14; B01D 69/02; B01D 69/14; B01D 71/02; B01D 71/34; C02F 1/44; C02F 1/78; C02F 101/36

(52) U.S. Cl. CPC C02F 1/725; B01D 61/145; B01D 69/02; B01D 69/14111; B01D 69/145; B01D 71/0281; B01D 71/34; C02F 1/444; C02F 1/78; B01D 2325/02831; B01D 2325/38; C02F 2101/36; C02F 2305/08

(57) ABSTRACT

Disclosed herein are compositions and methods for chemically degrading per- and polyfluorinated substances (PFAS), particularly aqueous PFAS, using ozone and metal oxides. The metal oxides may optionally be encapsulated in a zeolite and/or present in a membrane doped with said metal oxides. These compositions and methods can be used for remediation of PFAS in, for example, naturally occurring bodies of water or municipal water supplies.

### CROSS-REFERENCE TO RELATED APPLICATIONS

This application claims the benefit of priority to U.S. Provisional Application No. 63/566,324, filed Mar. 17, 2024, which is incorporated by reference herein in its entirety.

### BACKGROUND

Remediation of “forever chemicals” in waste and drinking water is a persistent societal problem that requires interdisciplinary solutions. Adsorption and separations of these chemicals from waste- and drinking water effluent are increasingly reliable but result in the accumulation of chemical waste streams for which remediation strategies are not well developed. Processes capable of decomposing these chemicals to innocuous derivatives are essential (Kwiatkowski, C. F., et al. Scientific Basis for Managing PFAS as a Chemical Class. Environmental Science & Technology Letters 2020, 7, 532-543).

Per- and polyfluoroalkyl substances (PFAS) and their derivatives are water-stable molecules that are difficult to activate due to the strength of the C—F bond and are highly hydrophobic. For water remediation, activation of these molecules must occur at or near room temperature to avoid considerable heating costs and to allow for operation at municipal drinking water facilities. Furthermore, conventional methods for PFAS decomposition can add new, potentially hazardous chemicals with unforeseen consequences to municipal and environmental water systems.

Thus, there exists a need for new methods and systems for PFAS decomposition. These needs and others are at least partially satisfied by the present disclosure.

### SUMMARY

In one aspect of the present disclosure, provided is composition for chemical degradation of PFAS, comprising a membrane doped with a metal oxide encapsulated in a zeolite.

In another aspect of the present disclosure, provided is a method for chemically degrading per- and polyfluorinated substances (PFAS), comprising contacting a metal oxide encapsulated in a zeolite with aqueous PFAS and ozone.

In yet another aspect of the present disclosure, provided is a method for chemically degrading PFAS, comprising contacting a membrane with PFAS and ozone, wherein the membrane is doped with a metal oxide.

In yet another aspect of the present disclosure, provided is method for chemically degrading PFAS, comprising contacting any of the disclosed compositions with aqueous PFAS and ozone.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF DRAWINGS

FIG. 1 depicts an overview of one aspect of the disclosure where PFCAs and PFSAs are catalytically decomposed using iron oxide incorporated zeolites (red cubes) in PVDF membranes and ozone.

FIG. 2 depicts PFOS adsorption isotherms for FAU zeolites of varied Si/Al⁷⁹ and Fe₂O₃ nanoparticles.⁸⁸

FIG. 3 depicts a design for a catalytic membrane for decomposition of PFAS molecules using ozone.

FIGS. 4A-4B depict preliminary data for PFOA ozonolysis over Fe₂O₃ powder. FIG. 4A shows a decrease in PFOA concentration with time, quantified by UPLC MS. FIG. 4B shows example UPLC MS traces showing decrease in PFOA peak area and formation of additional product(s). Reaction conditions: C_{PFOA,0}=1000 ppm, 10 cm³ solution volume, 215 cm³ min⁻¹ total gas flow, 60 mg/L O₃, balance O₂, 0.2 g Fe₂O₃.

FIG. 5 depicts glucose isomerization rates over hydrophobic (filled) and hydrophilic (open) Sn-Beta.¹⁵³

FIG. 6 depicts the NIPS method for casting iron particle embedded PVDF membranes.

FIG. 7 depicts N₂ adsorption isotherms for a PVDF membrane and MFI zeolite.

FIGS. 8A-8D depict the general setup of the study of catalyzed ozonolysis over metal oxides.

FIG. 9 depicts the setup of the gaseous ozonation reactor.

FIG. 10 depicts the process of PVDF-Fe₂O₃ catalytic membrane fabrication.

FIG. 11 depicts characterization of Fe₂O₃ encapsulated in MFI zeolite, showing the resulting diffractograms from XRD analysis for two synthesized batches of Fe₂O₃@MFI compared to Zeolyst MFI (Si/Al=25).

FIG. 12 depicts conversion as a function of starting concentration of PFOA. These reactions are performed under standard operating conditions at varying temperatures 25-60° C. without and with catalyst (Fe₂O₃). Conversions up to 99% are achievable at lower initial concentrations of PFOA. Conversions >90% are achievable with and without the presence of catalyst.

### DETAILED DESCRIPTION

It is appreciated that certain features of the disclosure, which are, for clarity, described in the context of separate aspects, can also be provided in combination with a single aspect. Conversely, various features of the disclosure, which are, for brevity, described in the context of a single aspect, can also be provided separately or in any suitable subcombination. Unless defined otherwise, all technical and scientific terms used herein have the same meaning as commonly understood by one of ordinary skill in the art. Methods and materials similar or equivalent to those described herein can be used in the practice or testing of the present disclosure.

### Definitions

In this specification and in the claims that follow, reference will be made to a number of terms, which shall be defined to have the following meanings:

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used in the specification and the appended claims, the singular forms “a,” “an” and “the” include plural referents unless the context clearly dictates otherwise. Thus, for example, reference to “a compound”, “a composition”, or “a cancer”, includes, but is not limited to, two or more such compounds, compositions, or cancers, and the like.

It should be noted that ratios, concentrations, amounts, and other numerical data can be expressed herein in a range format. It can be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it can be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

### Compositions

In one aspect of the present disclosure, provided is composition for chemical degradation of PFAS, comprising a membrane doped with a metal oxide encapsulated in a zeolite. As used herein, the term “per- and polyfluorinated substances” or “PFAS” refers to any one or more compound having multiple fluorine atoms attached to an alkyl chain, including, but not limited to, the compounds listed in TABLE 1.

In some aspects, the membrane can be hydrophobic. In some aspects, the membrane can include polyvinylidene fluoride (PVDF), polytetrafluoroethylene (PTFE), polyethylene (PE), polypropylene (PP) polysulfone (PSF), polyethersulfone (PES), polyacrylonitrile (PAN), cellulose acetate (CA), or any combination thereof.

In some aspects, the metal oxide can include Fe₂O₃, CuO, MnO₂, TiO₂, ZnO, CeO₂, V₂O₅ or any combination thereof.

In some aspects, the zeolite can be hydrophobic. In some aspects, the zeolite can include a Beta zeolite, an MFI zeolite, an LTA zeolite, an FAU zeolite, an MOR zeolite, an FER zeolite, a CHA zeolite, a mesoporous material (e.g., SBA-15 or MCM-41), or any combination thereof.

In some aspects, the zeolite can have a pore diameter of at least about 0.05 nm (e.g., at least about 0.1 nm, at least about 0.15 nm, at least about 0.2 nm, at least about 0.25 nm, at least about 0.3 nm, at least about 0.35 nm, at least about 0.4 nm, at least about 0.45 nm, at least about 0.5 nm, at least about 0.55 nm, at least about 0.6 nm, at least about 0.65 nm, at least about 0.7 nm, at least about 0.75 nm, at least about 0.8 nm, at least about 0.85 nm, at least about 0.9 nm, at least about 0.95 nm, at least about 1 nm). In some aspects, the zeolite can have a pore diameter of up to about 1 nm (e.g., up to about 0.95 nm, up to about 0.9 nm, up to about 0.85 nm, up to about 0.8 nm, up to about 0.75 nm, up to about 0.7 nm, up to about 0.65 nm, up to about 0.6 nm, up to about 0.55 nm, up to about 0.5 nm, up to about 0.45 nm, up to about 0.4 nm, up to about 0.35 nm, up to about 0.3 nm, up to about 0.25 nm, up to about 0.2 nm, up to about 0.15 nm, up to about 0.1 nm, up to about 0.05 nm).

It is considered that the zeolite can have a pore diameter ranging from any of the minimum values described above to any of the maximum values described above. For example, in some aspects, the zeolite can have a pore diameter of from about 0.05 nm to about 1 nm (e.g., from about 0.1 nm to about 0.95 nm, from about 0.15 nm to about 0.9 nm, from about 0.2 nm to about 0.85 nm, from about 0.25 nm to about 0.8 nm, from about 0.3 nm to about 0.75 nm, from about 0.35 nm to about 0.7 nm, from about 0.4 nm to about 0.65 nm, from about 0.45 nm to about 0.6 nm, from about 0.5 nm to about 0.55 nm, from about 0.05 nm to about 0.55 nm, from about 0.1 nm to about 0.5 nm, from about 0.15 nm to about 0.45 nm, from about 0.2 nm to about 0.4 nm, from about 0.25 nm to about 0.35 nm, from about 0.5 nm to about 1 nm, from about 0.55 nm to about 0.95 nm, from about 0.6 nm to about 0.9 nm, from about 0.65 nm to about 0.85 nm, from about 0.7 nm to about 0.8 nm).

In some aspects, the metal oxide encapsulated in the zeolite can have a concentration of at least about 0.1 wt % in the membrane (e.g., at least about 0.25 wt %, at least about 0.5 wt %, at least about 0.75 wt %, at least about 1 wt %, at least about 1.25 wt %, at least about 1.5 wt %, at least about 1.75 wt %, at least about 2 wt %, at least about 2.25 wt %, at least about 2.5 wt %, at least about 2.75 wt %, at least about 3 wt %, at least about 3.25 wt %, at least about 3.5 wt %, at least about 3.75 wt %, at least about 4 wt %, at least about 4.25 wt %, at least about 4.5 wt %, at least about 4.75 wt %, at least about 5 wt %). In some aspects, the metal oxide encapsulated in the zeolite can have a concentration of up to about 5 wt % in the membrane (e.g., up to about 4.75 wt %, up to about 4.5 wt %, up to about 4.25 wt %, up to about 4 wt %, up to about 3.75 wt %, up to about 3.5 wt %, up to about 3.25 wt %, up to about 3 wt %, up to about 2.75 wt %, up to about 2.5 wt %, up to about 2.25 wt %, up to about 2 wt %, up to about 1.75 wt %, up to about 1.5 wt %, up to about 1.25 wt %, up to about 1 wt %, up to about 0.75 wt %, up to about 0.5 wt %, up to about 0.25 wt %, up to about 0.1 wt %).

It is considered that the metal oxide encapsulated in the zeolite can have a concentration in the membrane ranging from any of the minimum values described above to any of the maximum values described above. For example, in some aspects, the metal oxide encapsulated in the zeolite can have a concentration of from about 0.1 wt % to about 5 wt % in the membrane (e.g., from about 0.25 wt % to about 4.75 wt %, from about 0.5 wt % to about 4.5 wt %, from about 0.75 wt % to about 4.25 wt %, from about 1 wt % to about 4 wt %, from about 1.25 wt % to about 3.75 wt %, from about 1.5 wt % to about 3.5 wt %, from about 1.75 wt % to about 3.25 wt %, from about 2 wt % to about 3 wt %, from about 2.25 wt % to about 2.75 wt %, from about 0.1 wt % to about 2.5 wt %, from about 0.25 wt % to about 2.25 wt %, from about 0.5 wt % to about 2 wt %, from about 0.75 wt % to about 1.75 wt %, from about 1 wt % to about 1.5 wt %, from about 2.5 wt % to about 5 wt %, from about 2.75 wt % to about 4.75 wt %, from about 3 wt % to about 4.5 wt %, from about 3.25 wt % to about 4.25 wt %, from about 3.5 wt % to about 4 wt %).

### Methods

In one aspect of the present disclosure, provided is a method for chemically degrading per- and polyfluorinated substances (PFAS), comprising contacting a metal oxide encapsulated in a zeolite with aqueous PFAS and ozone.

In another aspect of the present disclosure, provided is a method for chemically degrading PFAS, comprising contacting a membrane with PFAS and ozone, wherein the membrane is doped with a metal oxide.

In yet another aspect of the present disclosure, provided is method for chemically degrading PFAS, comprising contacting any of the disclosed compositions with aqueous PFAS and ozone.

In some aspects, the metal oxide can include Fe₂O₃, CuO, MnO₂, TiO₂, ZnO, CeO₂, V₂O₅ or any combination thereof.

In some aspects, the zeolite can be hydrophobic. In some aspects, the zeolite can include a Beta zeolite, an MFI zeolite, an LTA zeolite, an FAU zeolite, an MOR zeolite, an FER zeolite, a CHA zeolite, a mesoporous material (e.g., SBA-15 or MCM-41), or any combination thereof.

In some aspects, the membrane can be hydrophobic. In some aspects, the membrane can include polyvinylidene fluoride (PVDF), polytetrafluoroethylene (PTFE), polyethylene (PE), polypropylene (PP) polysulfone (PSF), polyethersulfone (PES), polyacrylonitrile (PAN), cellulose acetate (CA), or any combination thereof.

In some aspects, the zeolite can have a pore diameter of at least about 0.05 nm (e.g., at least about 0.1 nm, at least about 0.15 nm, at least about 0.2 nm, at least about 0.25 nm, at least about 0.3 nm, at least about 0.35 nm, at least about 0.4 nm, at least about 0.45 nm, at least about 0.5 nm, at least about 0.55 nm, at least about 0.6 nm, at least about 0.65 nm, at least about 0.7 nm, at least about 0.75 nm, at least about 0.8 nm, at least about 0.85 nm, at least about 0.9 nm, at least about 0.95 nm, at least about 1 nm). In some aspects, the zeolite can have a pore diameter of up to about 1 nm (e.g., up to about 0.95 nm, up to about 0.9 nm, up to about 0.85 nm, up to about 0.8 nm, up to about 0.75 nm, up to about 0.7 nm, up to about 0.65 nm, up to about 0.6 nm, up to about 0.55 nm, up to about 0.5 nm, up to about 0.45 nm, up to about 0.4 nm, up to about 0.35 nm, up to about 0.3 nm, up to about 0.25 nm, up to about 0.2 nm, up to about 0.15 nm, up to about 0.1 nm, up to about 0.05 nm).

It is considered that the zeolite can have a pore diameter ranging from any of the minimum values described above to any of the maximum values described above. For example, in some aspects, the zeolite can have a pore diameter of from about 0.05 nm to about 1 nm (e.g., from about 0.1 nm to about 0.95 nm, from about 0.15 nm to about 0.9 nm, from about 0.2 nm to about 0.85 nm, from about 0.25 nm to about 0.8 nm, from about 0.3 nm to about 0.75 nm, from about 0.35 nm to about 0.7 nm, from about 0.4 nm to about 0.65 nm, from about 0.45 nm to about 0.6 nm, from about 0.5 nm to about 0.55 nm, from about 0.05 nm to about 0.55 nm, from about 0.1 nm to about 0.5 nm, from about 0.15 nm to about 0.45 nm, from about 0.2 nm to about 0.4 nm, from about 0.25 nm to about 0.35 nm, from about 0.5 nm to about 1 nm, from about 0.55 nm to about 0.95 nm, from about 0.6 nm to about 0.9 nm, from about 0.65 nm to about 0.85 nm, from about 0.7 nm to about 0.8 nm).

In some aspects, the aqueous PFAS can have a concentration of at least about 10 ppm (e.g., at least about 20 ppm, at least about 30 ppm, at least about 40 ppm, at least about 50 ppm, at least about 75 ppm, at least about 100 ppm, at least about 150 ppm, at least about 200 ppm, at least about 250 ppm, at least about 300 ppm, at least about 350 ppm, at least about 400 ppm, at least about 450 ppm, at least about 500 ppm, at least about 600 ppm, at least about 700 ppm, at least about 800 ppm, at least about 900 ppm, at least about 1000 ppm, at least about 1500 ppm, at least about 2000 ppm, at least about 2500 ppm, at least about 3000 ppm, at least about 3500 ppm, at least about 4000 ppm, at least about 4500 ppm, at least about 5000 ppm). In some aspects, the aqueous PFAS can have a concentration of up to about 5000 ppm (e.g., up to about 4500 ppm, up to about 4000 ppm, up to about 3500 ppm, up to about 3000 ppm, up to about 2500 ppm, up to about 2000 ppm, up to about 1500 ppm, up to about 1000 ppm, up to about 900 ppm, up to about 800 ppm, up to about 700 ppm, up to about 600 ppm, up to about 500 ppm, up to about 450 ppm, up to about 400 ppm, up to about 350 ppm, up to about 300 ppm, up to about 250 ppm, up to about 200 ppm, up to about 150 ppm, up to about 100 ppm, up to about 75 ppm, up to about 50 ppm, up to about 40 ppm, up to about 30 ppm, up to about 20 ppm, up to about 10 ppm). In some aspects, the aqueous PFAS can have a concentration less than 10 ppm. In other aspects, the aqueous PFAS can have a concentration greater than 5000 ppm.

It is considered that the aqueous PFAS can have a concentration ranging from any of the minimum values described above to any of the maximum values described above. For example, in some embodiments, the aqueous PFAS can have a concentration of from about 10 ppm to about 5000 ppm (e.g., from about 20 ppm to about 4500 ppm, from about 30 ppm to about 4000 ppm, from about 40 ppm to about 3500 ppm, from about 50 ppm to about 3000 ppm, from about 75 ppm to about 2500 ppm, from about 100 ppm to about 2000 ppm, form about 150 ppm to about 1500 ppm, from about 200 ppm to about 1000 ppm, from about 250 ppm to about 900 ppm, from about 300 ppm to about 800 ppm, from about 350 ppm to about 700 ppm, from about 400 ppm to about 600 ppm, from about 450 ppm to about 500 ppm, from about 10 ppm to about 500 ppm, from about 20 ppm to about 450 ppm, from about 30 ppm to about 400 ppm, from about 40 ppm to about 350 ppm, from about 50 ppm to about 300 ppm, from about 75 ppm to about 250 ppm, from about 100 ppm to about 200 ppm, from about 500 ppm to about 5000 ppm, from about 600 ppm to about 4500 ppm, from about 700 ppm to about 4000 ppm, from about 800 ppm to about 3500 ppm, from about 900 ppm to about 3000 ppm, from about 1000 ppm to about 2500 ppm, from about 1500 ppm to about 2000 ppm).

In some aspects, the aqueous PFAS can be in a naturally occurring body of water or a municipal water supply.

In some aspects, the method can further include heating the aqueous PFAS to a temperature of at least about 50° C. (e.g., at least about 60° C., at least about 70° C., at least about 80° C., at least about 90° C., at least about 100° C.). In some aspects, the method can further include heating the aqueous PFAS to a temperature of up to about 100° C. (e.g., up to about 90° C., up to about 80° C., up to about 70° C., up to about 60° C., up to about 50° C.).

It is considered that the method can further include heating the aqueous PFAS to a temperature ranging from any of the above minimum values to any of the above maximum values. For example, in some aspects, the method can further include heating the aqueous PFAS to a temperature of from about 50° C. to about 100° C. (e.g., from about 60° C. to about 90° C., from about 70° C. to about 80° C., from about 50° C. to about 80° C., from about 60° C. to about 70° C., from about 70° C. to about 100° C., from about 80° C. to about 90° C.).

In some aspects, the step of contacting a metal oxide encapsulated in a zeolite with aqueous PFAS and ozone can occur for at least about 1 hour (e.g., at least about 2 hours, at least about 4 hours, at least about 8 hours, at least about 16 hours, at least about 24 hours, at least about 32 hours, at least about 40 hours, at least about 48 hours). In some aspects, the step of contacting a metal oxide encapsulated in a zeolite with aqueous PFAS and ozone can occur for up to about 48 hours (e.g., up to about 40 hours, up to about 32 hours, up to about 24 hours, up to about 16 hours, up to about 8 hours, up to about 4 hours, up to about 2 hours, up to about 1 hour). In some aspects, the step of contacting a metal oxide encapsulated in a zeolite with aqueous PFAS and ozone can occur for longer than 48 hours.

It is considered that the step of contacting a metal oxide encapsulated in a zeolite with aqueous PFAS and ozone can occur for a duration ranging from any of the minimum values described above to any of the maximum values described above. For example, in some aspects, the step of contacting a metal oxide encapsulated in a zeolite with aqueous PFAS and ozone can occur for from about 1 hour to about 48 hours (e.g., from about 2 hours to about 40 hours, from about 4 hours to about 32 hours, from about 8 hours to about 24 hours, from about 1 hour to about 16 hours, from about 2 hours to about 8 hours, from about 16 hours to about 48 hours, from about 24 hours to about 40 hours).

In some aspects, the PFAS can be chemically degraded to CO₂ and HF/F⁻. In some aspects, the PFAS can be entirely chemically degraded to CO₂ and HF/F⁻.

### EXAMPLES

### Example 1: Ozone-Assisted Decomposition of PFAS Over Catalytic Membranes

A promising route for PFAS degradation is the catalytic decomposition of PFAS, which circumvents the thermodynamic stability of these molecules. Degradation of C₇₊ PFAS molecules can be performed over iron oxide (Fe₂O₃), an earth-abundant and ubiquitous mineral that is not particularly hazardous to humans (iron is present in drinking water and iron oxide is an FDA-approved coloring agent in medicines and cosmetics), with the addition of ozone.² Ozone is used in secondary water treatment to remove pathogens and trace organic contaminants and approaches to apply ozone at water treatment plants for disinfection are already known, suggesting such a process is economically viable and welcomed by municipal water managers. Other PFAS degradation techniques, such as sonochemical degradation and electrochemical oxidation approaches, require techniques that the water treatment industry does not currently use, and would thus take extensive demonstrations of their effectiveness and safety. The combination of ozone treatment and iron oxide catalysts does not complicate water treatment by adding any new and potentially harmful substances and can provide significant societal benefits by effectively degrading PFAS.

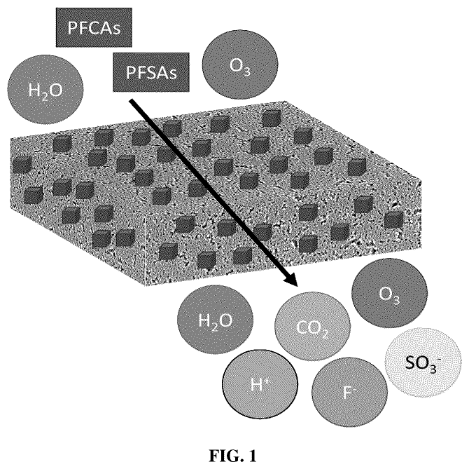

To implement this process, the decomposition reaction pathways, kinetics, and mechanisms must be understood, along with the desirable structural features of the catalysts, to design improved catalytic materials for eventual implementation at scale. Catalysts also must be integrated into a membrane to allow for a high throughput of aqueous solutions, to allow for stability with time on stream, and to prevent loss of catalyst. As shown in FIG. 1, a study was conducted which envisions an iron oxide-incorporated zeolite catalyst, embedded in a micro-/ultrafiltration polyvinylidene difluoride (PVDF) membrane, for the decomposition of PFAS molecules after concentration from existing adsorbents like ion exchange resins or activated carbons or from retentates from nanofiltration (NF) and reverse osmosis (RO) processes.³⁻⁸ This catalytic membrane can be operated in dead-end mode so no concentrate stream is generated.

If iron oxide particles within zeolites are subsequently embedded in PVDF membranes, then PFAS molecules can be concentrated at the iron oxide catalyst, causing an increase in degradation rate and enabling degradation of short chain PFAS molecules. This example includes the following:
1) Determination of the reaction kinetics and mechanism for ozonation of PFAS molecules with iron oxide and iron oxide containing zeolites, including investigation of short-chain PFAS molecule decomposition.
2) Development of hydrophobic zeolite-encapsulated iron oxide catalysts and catalytic PVDF membranes that include iron oxide particles and iron oxide encapsulated in the pores of zeolites.
3) Determination of the impact of embedded iron oxide and iron oxide incorporated zeolites within PVDF membranes on membrane performance and the product distribution of PFAS degradation with ozone compared to the catalyst alone.

This strategy to combine ozone with an engineered catalytic membrane can decompose long and short chain PFAS molecules without adding the burden of new chemicals or energy requirements on industrial wastewater and municipal water treatment facilities. While other strategies can separate but not decompose PFAS from water,¹ or decompose only the longer chain PFAS molecules, many of these strategies do not decompose PFAS to benign byproducts or activate short chain PFAS molecules, thus leaving the PFAS problem only partially addressed. Additionally, many of the other techniques studied for PFAS decomposition are more operationally/energetically expensive or have a difficult path to full-scale commercialization. Membranes and ozone are both already used in full-scale water treatment plants.

Adsorptive and NF/RO membrane techniques must be equipped with a decomposition technique to adequately treat PFAS contamination.¹ This research can elucidate reaction mechanisms (specifically the surface catalyzed reactions), PFAS degradation products, and strategies for the decomposition of small PFAS molecules, while also determining the impacts of incorporation of these catalytic functions in membranes. Factors that determine the long-term stability and performance of the catalytic membranes can be reported. In addition, the use of ozone can help prevent possible membrane fouling from concentrated regeneration or retentate solutions. Ultimately, disclosed herein is a viable catalytic membrane for the ozonation of PFAS molecules that can be implemented in future studies at the pilot scale. Once established for PFAS molecules, this ozone-catalytic membrane approach can be adapted to other emerging aqueous organic pollutants such as pharmaceuticals, pesticides, and chemical warfare agents.

### BACKGROUND

PFAS molecules are fluorinated aliphatic molecules with many unique properties, such as being hydrophobic and lipophobic due to their C—F bonds and being water soluble due to their carboxylic acid (in perfluoroalkyl carboxylic acids, PFCAs) or sulfonic acid (in perfluoroalkyl sulfonic acids, PFSAs) end groups.⁹ These properties led to their extensive use in stain repellants, non-stick cookware, and fire-fighting foams.¹ Perfluorooctanoic acid (PFOA) and perfluorooctanesulfonic acid (PFOS) are the two most detected PFAS compounds in water.^{10,11} PFOA and PFOS are bioaccumulative and have been linked to numerous health conditions, such as thyroid disorders, pregnancy-related issues, reduced fertility, cancers, and immunotoxicity.^{1,9} Once regulations started to be enforced on PFOA and PFOS, industries shifted to using short-chain alternatives such as perfluoro-2-propoxypropanoic acid (GenX), perfluorobutanoic acid (PFBA), perfluorobutane sulfonic acid (PFBS), and perfluorohexane sulfonic acid (PFHxS).^{1,11} However, this move to shorter-chain PFAS compounds is concerning because the EPA has deemed GenX and its decomposition product, hexafluoropropylene oxide dimer acid, more toxic than PFOA.¹² In June 2022, the EPA announced new health advisory levels for PFOS (20 ppq), PFOA (4 ppq), GenX (10 ppt), and PFBS (2,000 ppt).¹³ In March 2023, the EPA proposed National Primary Drinking Water Regulations for PFOA, PFOS, PFNA, GenX, PFHxS, and PFBS to establish legally enforceable Maximum Contaminant Levels.¹⁴ Because of PFAS's ubiquitous use without much, if any, regulation for many years, PFAS has contaminated many water supplies around the world. In fact, PFAS was detected in the blood serum of 99% of the United States general population tested between 1999 and 2012.^{1,9} Freshwater fish in the US have been identified as a significant source of PFAS exposure to humans.¹⁵ As such, there has been an explosion of research over the past 10 years on PFAS' fate in drinking water treatment plants and new technologies to remove PFAS from water.^{9-11,16-27} However, the most promising and used techniques, such as sorption processes and high-pressure membrane processes, still lead to environmental issues. Sorption processes, such as ion-exchange resins and activated carbons, have to be regenerated to be re-used, however, these regeneration streams lead to the accumulation of PFAS in concentrated effluent streams.⁹ High-pressure membrane processes, such as NF and RO,³⁻⁸ produce a PFAS concentrated retentate stream that is approximately 20% of the feed volume.⁹ Therefore, degradation techniques need to be developed to decompose PFAS molecules in these streams into non-hazardous compounds, especially because PFAS molecules are estimated to have lifetimes in the thousands of years.¹

Incineration is currently used to regenerate activated carbons.^{9,28} However, this technique is expensive, as the temperature has to be at least 700° C., and hazardous, as incomplete degradation can lead to the release of short chain PFAS into the environment.⁹ Other strategies, namely advanced oxidation and reduction processes, have been developed to degrade PFAS in aqueous solutions.²⁹⁻³¹ These techniques include the use of supercritical fluids,³² sodium hydroxide in polar aprotic solvents,³³ photolytic methods,³⁴⁻³⁶ photocatalytic methods,^{37,38} sonolytic methods,³⁹⁻⁴¹ electrochemical methods,⁴²⁻⁴⁵ persulfate and peroxide oxidation methods,⁴⁶⁻⁴⁹ and ionizing radiation methods.^{29,50-52} These strategies are limited by difficulties in effectively distributing visible light, UV light, and sonication with sufficient intensity in large flowing process streams, and by high energy costs (temperature, pressure, electrochemical, sonolytic, UV).^{29,53} Persulfate and peroxide oxidation require additional external chemicals that can lead to new contaminants in process streams. Ionizing radiation utilizes gamma or electron beam irradiation to create hydroxide and hydrogen radicals and hydrated electrons.⁵⁰ These processes require either a gamma-source or an electron accelerator,²⁹ which are unlikely to appeal to water treatment plants. Pd nanoparticle films (~15 nm thick) dispersed on hollow fiber membranes have been reported to defluorinate PFOA via hydrogenation,⁵⁴ however, these precious metal films are costly to produce at scale and concern over flammable H₂ use by water treatment facilities could impede adoption.

Ozone generation is not expensive, and it is already used in water treatment^{55,56} to remove viruses,⁵⁷ organics,⁵⁶ and trace contaminants including endocrine disruptors and pharmaceuticals.^{56,58} Ozone is generated from oxygen (or air) using either a corona discharge or UV light, so at a high level, the use of ozone for water treatment uses external energy sources to activate a pure stream of a gaseous molecule rather than directly activating a contaminated liquid for which contacting mechanisms are less energy efficient. Ozone has been shown to degrade molecules ranging from PFAS precursors to fully fluorinated, terminal PFAS.^{49,59,60} However, ozone alone does not effectively decompose PFAS molecules,^{2,29} though it is effective in generating OH radicals (with similar or more effective radical production than UV/H₂O₂ processes²⁹). Catalytic decomposition of PFAS molecules using ozone oxidants and iron oxide catalysts was recently reported to provide an increased activity for PFAS decomposition.²

The degradation products, mechanisms, and kinetics, and the role of pH in catalytic PFAS ozonation are not known,² though there is a large body of literature on catalytic ozonation of aqueous organic molecules that proffers varying, and often contradictory, mechanistic proposals.⁶¹ Some studies proposed that redox active metals and metal oxides assist in hydroxyl radical production from water at ambient temperature while others propose adsorption of organic substrates is followed by the attack of the catalyst-substrate complex by ozone in either Eley-Rideal- or Langmuir-Hinshelwood-type steps.⁶¹ It is plausible for radical oxidants (e.g., OH·) to activate strong C—F bonds, as similar intermediates have been reported to activate strong C—H bonds in methane (C—H bond dissociation enthalpy (BDE) ~439 kJ mol⁻¹).⁶²⁻⁶⁴ Efficacy in catalytic ozonation of aqueous organic acids is reportedly a strong function of solution pH as a result of variation in the charge of the surface and fraction of organic reagents that are dissociated in solution,⁶¹ however, the effect of pH on thermal catalytic ozonation of PFAS molecules has not been reported. Degradation of PFAS by ozone in the absence of catalyst increases with increasing pH (>7),^{59,65} while the photocatalytic decomposition of PFAS by ozone and TiO₂ increases with decreasing pH (for pH 3-9).⁶⁶

Iron oxide is reported to be a p-type oxide,⁶⁷ a characteristic reported to be necessary for ozone decomposition⁶⁷ that generates OH radicals in solution and surface superoxide (O₂⁻) and peroxide (O₂²⁻) ions in gas-phase catalysis⁶⁷ with similar ozone decomposition activity (within 2×) to the most reactive metal oxide for ozone decomposition (MnO₂),⁶⁷ and has been reported to decompose PFAS molecules in the presence of ozone.² While the rate constant for the decomposition of benzene (C—H BDE ~470 kJ mol⁻¹) by OH radicals is reportedly ~109 M s^{-1,6} the rate constant for ammonium perfluorooctanoate degradation by OH radicals was estimated to be ≤3*10⁷ M⁻¹ s⁻¹ and the decomposition rate was not decreased by the presence of thiocyanate (a radical scavenger).⁶⁹ Hydroxyl radicals activate organic molecules via abstracting hydrogen atoms, thus the lack of C—H in perfluorinated molecules requires the formation of hydroxyl anions via thermodynamically disfavored removal of electrons from electronegative fluorine atoms to activate PFAS molecules with hydroxyl radicals.⁷⁰ This resistance to oxidization is in part what originally motivated the use of perfluorinated molecules as fire-fighting foams.^{70 67}. Due to the difficulties in abstracting electrons from fluorine, it has been previously proposed that any attempts to oxidize PFAS molecules with oxygen-based radicals will not be successful.⁷¹ Thus, decomposition of PFAS molecules by ozone alone, which leads to the generation of OH radicals in solution, is not typically observed,^{2,72} except at high ozone concentrations and pH >7.59,⁶⁵ The observed PFAS molecule decomposition in the presence of both ozone and iron oxide (in the absence of controlled pH) most likely occurs through a (currently unknown) surface-catalyzed mechanism that does not include the reaction of OH radicals with PFAS molecules in solution. Superoxide (O₂·⁻) and hydroperoxyl (HO₂·) radicals have been reported to decompose PFAS molecules,⁷¹ and superoxides were reported to form during photocatalytic, surface-catalyzed redox reactions that decompose PFAS molecules over Fe(III) catalysts.⁷¹ However, recent research suggests superoxides in solution cannot catalyze PFCA decomposition,⁷³ suggesting the observed PFCA decomposition over iron oxide occurs due to the formation of surface-bound oxygen species followed by surface-catalyzed reactions that are more effective than hydroxyl or superoxide mediated homogeneous reactions. For example, a hypothetical series of composite reaction steps for surface-catalyzed PFCA decomposition with ozone is given by SCHEME 1, where * denotes an unoccupied surface site and On* denotes an active surface oxygen species (e.g., peroxide, superoxide, or hydroperoxyl).

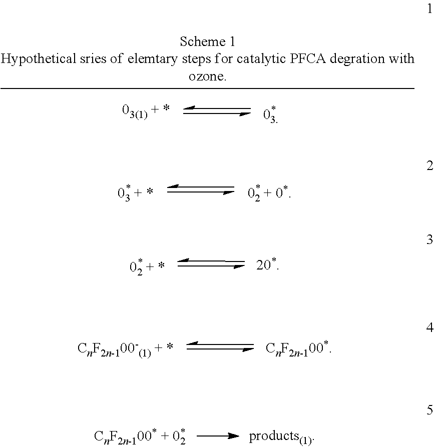

Assuming steps 1-4 are quasi-equilibrated and all sites are empty due to the low concentrations of ozone and PFCA, and that step five is the sole rate determining step involving decomposition of adsorbed PFCA and a reactive oxygen-containing species on the surface, the mechanistically derived rate law is given by EQ. 1, where Kᵢ is the equilibrium constant for step i, kᵢ is the rate constant for step i, [j] is the concentration of species j in the liquid phase and [L] is the concentration of active sites in the reactor.

$$\frac{{r}_{degradation}}{[ L ]} = \frac{{( {K}_{1} {K}_{2} )}^{2 / 3}}{{( {K}_{3} )}^{1 / 3}} {K}_{4} {{k}_{5} [ {C}_{n} {F}_{2 n - 1} {OO}_{( l )}^{-} ] [ {O}_{3 ( l )} ]}^{2 / 3} \qquad ( EQUATION 1 )$$

The rate law in EQ. 1 includes the first order dependence on PFAS concentration⁷² and 2/3 order dependence of ozone decomposition over metal oxides on ozone concentration reported elsewhere,⁶⁷ though it is stressed that this is only one of many plausible rate laws for PFAS molecule degradation with ozone and is used here to guide the ensuing description of the existing literature and the present disclosure.

Smaller chain PFAS molecules (C<7) are more difficult to decompose than C₈₊ analogs,² as expected based on the higher ratio of primary C—F bonds (C—F BDE: ~500 KJ mol⁻¹) to secondary C—F bonds (C—F BDE: ~450 kJ mol⁻¹) in shorter chain PFAS molecules.³⁵ Short chain PFAS molecules can form during decomposition of longer chain PFAS molecules, as C—C bonds are weaker (C—C BDE: ~420 kJ mol⁻¹) than C—F bonds.⁷¹ Typically, elevated temperatures are necessary to overcome the thermodynamic hurdles associated with activating strong bonds like the C—F bonds in short chain PFAS molecules (reflected in smaller values of k₅ in EQ. 1). The C—F bonds in PFAS molecules are similar in strength to the C—H bonds in methane, and heterogeneously catalyzed methane activation typically occurs at temperatures above 400° C.^{74,75} However, metalloenzymes activate strong bonds at ambient temperature by combining favorable primary binding sites and secondary reaction pockets, such as in the methane monooxygenase (MMO) enzyme that activates methane at ambient temperature.⁷⁶ Providing a favorable adsorption environment for the decomposition of PFAS molecules in a stable, synthetic heterogeneous catalyst requires that the polarity of the catalyst and the reactants are similar, resulting in increasingly negative enthalpies of adsorption (increased values of K₁ and K₄ in EQ. 1) that compensate for the small magnitude of the intrinsic PFAS degradation rate constant (k₅ in EQ. 1). As a result, correspondence in polarity between the catalytic adsorbent and PFAS molecules is critical to improving PFAS decomposition performance.

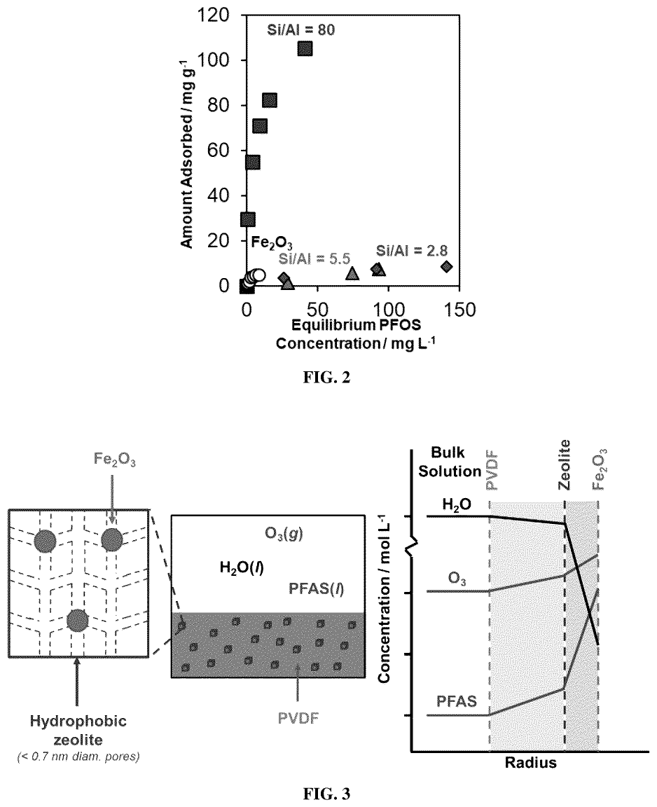

The use of PVDF as the membrane material can increase the concentration of PFAS molecules at the catalysts, as PVDF has been shown to adsorb PFOA molecules.⁷⁷ After the initial concentration of PFAS molecules in the membrane, preferential adsorption of PFAS at the catalyst surface requires the use of a hydrophobic catalyst. The PFAS adsorption capacity of faujasite (FAU) zeolites increased by a factor of ~30× and approached that of activated carbons when the Si/Al of commercial zeolites (a proxy for hydrophobicity⁷⁸) was increased from ~2.8 to 80 (FIG. 2),⁷⁹ however, this was accompanied by a decrease in pore aperture sizes from 1.0 to 0.6 nm that likely leads to enthalpic benefits due to favorable van der Waals interactions of PFAS molecules (~0.56 nm diameter for F-alkyl chains⁸⁰) with the pore walls.^{81,82} Adsorption of PFOA and PFOS in Al-free Beta zeolites reached ~370 mg PFOA/g zeolite, a ~2 fold improvement relative to activated carbon.⁸³ Similarly, ozone is less polar than water, reflected in dipole moments of 0.46 D for ozone compared to 1.85 D for water.⁶¹ Increasing the Si/Al ratio (from 10 to 3000)⁸⁴ and decreasing the pore diameter (from 2.0 nm to 0.55 nm)^{84,85} of zeolites resulted in increased ozone adsorption.⁸⁵ Ozone has been reported to be ten times more soluble in perfluorinated solvents than in water,⁸⁶ so PFAS and ozone molecules can interact favorably within the pores of hydrophobic zeolites.

The use of a PVDF membrane and a hydrophobic catalyst can promote both PFAS and ozone adsorption and lead to favorable conditions for PFAS decomposition at ambient temperature. For example, increased decomposition of organic pollutants by ozone was reported over Fe-containing mesoporous materials (Fe-MCM-41) when the hydrophobicity of the catalyst was increased.⁸⁷ Also, the favorable adsorption environment provided by non-polar siloxane bonds in zeolites of high Si/Al ratios is beneficial as iron oxide alone only weakly adsorbs PFAS (FIG. 2).^{10,88,89} Encapsulating iron oxide within the hydrophobic pores of a membrane-embedded zeolite (FIG. 3) is expected to maximize the rate of PFAS ozonation by (i) maximizing ozone and PFAS concentrations at the Fe₂O₃ catalyst, (ii) stabilizing bimolecular transition states for PFAS decomposition through favorable van der Waals interactions with zeolite pore walls (increasing k₅ in EQ. 1), and (iii) reducing the entropic penalties for solvent reorganization⁹⁰ that may exist when PFAS molecules decompose into multiple fragments by reducing intrapore water concentrations (increasing k₅ in EQ. 1). Increasing surface coverages of reactants and decreasing transition state energies can allow for increased reactivity in PFAS decomposition and even decomposition of recalcitrant short chain PFAS molecules. Assuming a Langmuir-Hinshelwood-type rate law (EQ. 1) for surface-catalyzed PFAS degradation and positive-order kinetics for PFAS degradation with respect to both PFAS and ozone concentration, increasing the equilibrium constants for adsorption of PFAS and ozone (K₁ and K₄ in EQ. 1, by at least 10× each) by increasing the hydrophobicity of the catalyst can increase PFAS decomposition rates by at least an order of magnitude. This can allow for the decomposition of PFAS molecules using solely ozone and Fe₂O₃ at rates greater than those observed for trifunctional combinations of persulfate+O₃+Fe₂O₃ or UV+O₃+TiO₂ that either add additional chemicals to water treatment processes or increase energy requirements for PFAS degradation.

Short chain PFAS molecules are less hydrophobic than longer chain PFAS molecules,⁷² resulting in differences in adsorption energies as a function of carbon number.⁹¹ As a result, zeolites with lower Si/Al ratios (decreased hydrophobicity) may be preferred for adsorption and decomposition of smaller PFAS molecules. Further studies on the effects of zeolite hydrophobicity on adsorption and decomposition of PFAS molecules of varied carbon number are beneficial to understand these effects, as control over the polarity of the zeolite framework can allow for tuning the adsorption enthalpy of PFAS molecules of varied carbon numbers. Finally, as the study envisions the implementation of this catalytic membrane for remediation of a small, concentrated stream of PFAS (FIG. 1), this stream can be heated to mild temperatures if the improvement in short chain PFAS molecule decomposition warranted the increased operational cost from heating. Increasing temperature is expected to increase PFAS degradation rates due to the Arrhenius dependence of rate constants on temperature, and this has been observed in the conversion of nitrobenzene during catalytic ozonation that increased from 15% to 85% as temperature increased from 7° C. to 37° C.⁹² The impact of temperature can be explored as an additional lever for improving the decomposition of short chain PFAS molecules.

The optimal iron-oxide containing catalyst of controlled hydrophobicity can be embedded in a membrane to further concentrate PFAS at catalytic particles, allow high throughput of water based on convective flow for membranes vs diffusive flow for resin materials,⁹³⁻⁹⁵ and prevent fouling and damage to the membrane from loose catalyst particles in solution (FIG. 3).⁹⁶ PVDF membranes have been used previously as the base substrate for various catalytic membranes.^{97,98} TiO₂, ZnO, and CuFe₂O₄ have been embedded into PVDF membranes for photocatalysis.⁹⁹⁻¹⁰⁴ Iron and iron oxide based particles have been embedded in a variety of membranes, including PVDF,¹⁰⁴⁻¹⁰⁹ and, along with H₂O₂, used to degrade organic contaminants and prevent membrane fouling.¹¹⁰⁻¹¹² Catalytic membranes also have been used in conjunction with ozone.^{113,114} This is a common approach for organic degradation and fouling reduction for ceramic membranes and nanoparticle incorporated ceramic membranes.¹¹⁵⁻¹¹⁸ PVDF is an excellent polymeric material for use with ozone due to its resistance to ozone degradation.^{113,114} Iron oxide nanoparticles have been incorporated in ceramic membranes and along with ozone used to remove heavy metals,¹¹⁹ organics,^{120,121} and foulants.^{121,122} Ozone is typically used with PVDF membranes to prevent and reduce membrane fouling and/or degrade organic contaminants without PVDF degradation.¹²³⁻¹²⁹ Yu, et al. combined PVDF membranes coated with MnO₂ and ozone to prevent membrane fouling.¹³⁰ Li and Yueng coated a PVDF membrane with iron oxide nanoparticles supported on powder activated carbon and combined it with ozone to degrade N,N-diethyl-meta-toluamide.⁹⁶ Other studies have used free catalyst in solution with a PVDF membrane to prevent catalyst loss.^{129,131} In summary, an extensive literature precedent supports the approach of embedding iron oxide and iron oxide-containing zeolites for use as a catalytic membrane without fear of degrading the PVDF membrane itself. Additionally, ozone can provide an added benefit of reducing possible membrane fouling when used with concentrated regeneration or retentate solutions.

This study explores the incorporation of iron oxide and iron-containing catalysts in PVDF membranes and determine whether these materials can be stably embedded in the membrane without loss of performance on a per mass catalyst basis. Functionalizing the external surfaces of zeolite crystallites can provide the dual benefit of increasing their hydrophobicity, creating an enthalpic pump to draw PFAS towards active centers on iron oxide surfaces within zeolitic pores, while also enabling the incorporation of the crystallites with the PVDF membrane and conferring increased hydrothermal stability of both the catalyst particles and the catalyst-membrane composite.

Kinetic and Mechanistic Studies of PFAS Molecule Degradation Over Fe₂O₃ Catalysts

Measuring PFOA degradation kinetics: This study can include fundamental kinetic studies of PFAS ozonation in liquid phase batch reactors loaded with aqueous PFAS molecules (TABLE 1) and a continuous flow of ozone and analyze the reactor contents as a function of time using online GC (to detect organic products, COₓ, and O₂), an online ozone analyzer, and offline UPLC-MS (to quantify dilute PFAS molecules and their degradation products) to quantify initial rates and kinetic parameters (e.g., rate and equilibrium constants). Further, ultra-performance liquid chromatography coupled with quadrupole time-of-flight mass spectrometry (UPLC-QTOF-MS)⁴ and NMR can be used to identify and quantify decomposition products in ppb levels, as prior catalytic PFAS ozonolysis studies reported only reactant consumption rates but not the identities of the products formed.²

TABLE 1
PFAS molecules.

| | |
|---|---|
| PFCAs | PFSAs |
| 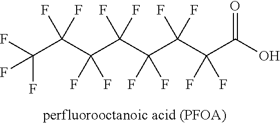 [SMILES: O=C(O)C(F)(F)C(F)(F)C(F)(F)C(F)(F)C(F)(F)C(F)(F)C(F)(F)F] | 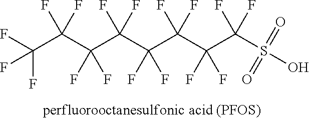 [SMILES: O=S(=O)(O)C(F)(F)C(F)(F)C(F)(F)C(F)(F)C(F)(F)C(F)(F)C(F)(F)C(F)(F)F] |
| 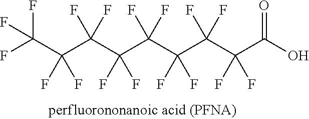 [SMILES: O=C(O)C(F)(F)C(F)(F)C(F)(F)C(F)(F)C(F)(F)C(F)(F)C(F)(F)C(F)(F)F] | 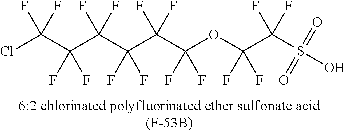 [SMILES: O=S(=O)(O)C(F)(F)C(F)(F)OC(F)(F)C(F)(F)C(F)(F)C(F)(F)C(F)(F)C(F)(F)Cl] |
| 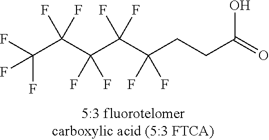 [SMILES: O=C(O)CCC(F)(F)C(F)(F)C(F)(F)C(F)(F)C(F)(F)F] | 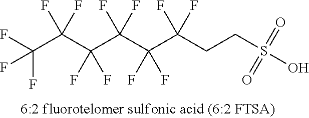 [SMILES: O=S(=O)(O)CCC(F)(F)C(F)(F)C(F)(F)C(F)(F)C(F)(F)C(F)(F)F] |
| 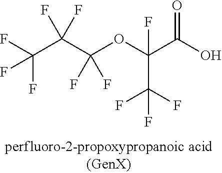 [SMILES: O=C(O)C(F)(OC(F)(F)C(F)(F)C(F)(F)F)C(F)(F)F] | 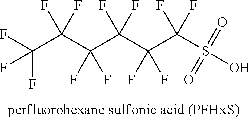 [SMILES: O=S(=O)(O)C(F)(F)C(F)(F)C(F)(F)C(F)(F)C(F)(F)C(F)(F)F] |
| 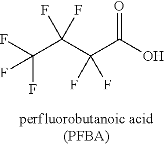 [SMILES: O=C(O)C(F)(F)C(F)(F)C(F)(F)F] | 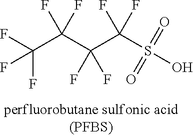 [SMILES: O=S(=O)(O)C(F)(F)C(F)(F)C(F)(F)C(F)(F)F] |

Other

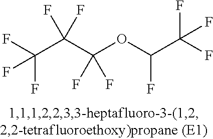 [SMILES: FC(OC(F)(F)C(F)(F)C(F)(F)F)C(F)(F)F]

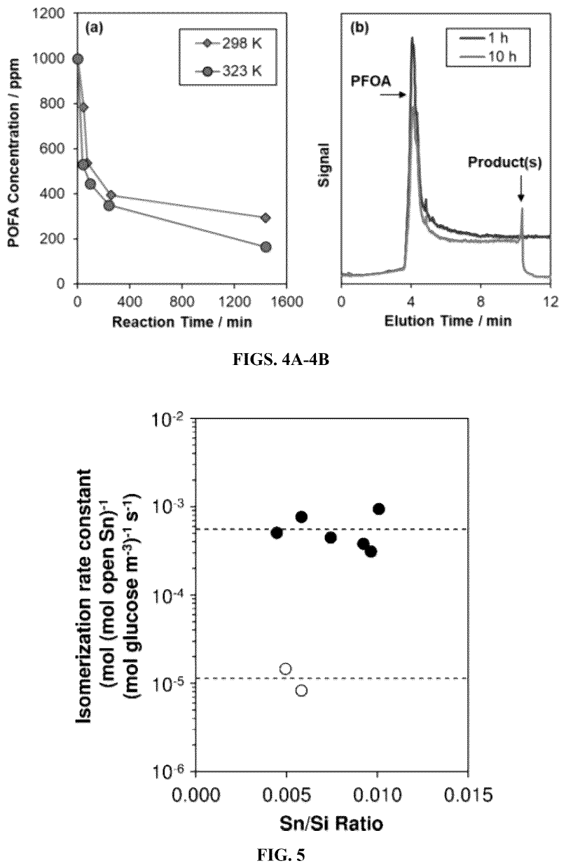

Results show that PFOA is consumed readily in the presence of ozone and Fe₂O₃ at 298 K, and the amount of PFOA removed increases at 323 K (FIG. 4A), demonstrating that the decrease in PFOA concentration observed here and previously by Franke et al.² results not only from adsorption, as the amount removed would decrease with increasing temperature if removal resulted only from adsorption, but also from catalytic decomposition. Repeating the analysis of the 1440 min data point from reaction of PFOA with ozone and Fe₂O₃ at 50° C. (FIG. 4A, red data series) by LC-MS using EPA method 1633 quantified 99.3% PFOA conversion with no detectable decomposition products. UPLC-MS spectra for the reaction products quantify decreased PFOA concentration and evince formation of new peaks for a mixture of products (FIG. 4B). Initial studies can use bulk iron oxide or mixed Fe₂O₃—SiO₂ catalysts and can determine the impact of ozone concentration, PFAS concentration, solution pH, and temperature on C₈₊ PFAS molecule degradation, as these are currently unknown.

Reactant concentrations can be varied beyond those typically observed in water treatment to determine the full reaction rate law before making simplifications based on the surface coverage regimes typically encountered in practice (i.e., assuming an empty surface and leading to similar expressions to EQ. 1). Increasing PFAS concentration above the parts-per-billion level can lead to the population of active sites that lead to sub-unity apparent reaction orders with respect to PFAS concentration that allows for subsequent quantification of PFAS adsorption equilibrium constants that are otherwise coupled with intrinsic rate constants in Langmuir-Hinshelwood rate laws (i.e., K₄ and k₅ in EQ. 1). For example, assuming the surface is populated by empty sites and PFCA using the nomenclature from SCHEME 1 leads to EQ. 2, which in combination with data from the first order PFCA concentration regime can allow for quantification of K₄.

$$\frac{{r}_{degradation}}{[ L ]} = \frac{{( {K}_{1} {K}_{2} )}^{2 / 3}}{{( {K}_{3} )}^{1 / 3}} \frac{{K}_{4} {{k}_{5} [ {C}_{n} {F}_{2 n - 1} {OO}_{( l )}^{-} ] [ {O}_{3 ( l )} ]}^{2 / 3}}{{( 1 + {K}_{4} [ {C}_{n} {F}_{2 n - 1} {OO}_{( l )}^{-} ] )}^{2}} \qquad ( EQUATION 2 )$$

By measuring values of K₄ at varied temperatures (20-50° C.), the study can quantitatively compare enthalpies of PFAS adsorption between catalysts of varied structure and polarity to guide rational catalyst design and improve performance in catalytic PFAS degradation. By including tert-butanol and thiocyanate, known radical scavengers,^{61,69} in reaction mixtures, this study can determine if radical pathways in solution phase are kinetically relevant, as reported mechanisms for ozonation of aqueous organic contaminants are inconsistent with respect to the role of solution-phase vs. surface-catalyzed reactions.^{61,73}

Electrostatic attraction between dissociated PFAS molecules in solution and metal oxide surfaces impacts adsorption equilibrium.^{61,133} Depending on the point of zero charge (pZC) of a metal oxide, the surface is either positively charged (M-OH₂⁺; pH<pZC), neutral (M-OH; pH=pZC) or negatively charged (M-O⁻; pH>pZC).¹³⁴ Thus, operating at high enough pH to maintain PFAS molecules in their anionic forms (pKa ~0-4)^{135, 136} and metal oxide surfaces in positively charged states can avoid repulsion between adsorbates and adsorbents.¹³³ The benefits of electrostatic attraction between anionic PFAS reactants and catalytic surfaces are reflected in increased photocatalytic PFOA degradation rates with decreasing pH (from 8 to 3) over TiO₂ (pZC ~6.25).⁶⁶ Decomposition of ozone in solution is prevalent at pH=11 but not observed at pH 4-5,⁵⁹ thus failure to maintain sufficiently low pH to prevent homogeneous ozone decomposition can complicate interpretation of kinetic data. Once mechanistic information is gathered for degradation of PFAS molecules at controlled pH (below the pZC of SiO₂, zeolites, and Fe₂O₃ of ~4.2, 5.0-9.5, and 7.0-9.0, respectively), this study can determine the impact of elevated pH on PFAS degradation rates, as sorbent regeneration solutions are likely to be at high pH (~11-13).¹⁴²⁻¹⁴⁴

Initially, kinetic studies can focus on PFOA, a Co PFCA that is commonly detected in water samples and that has previously been reported to be degraded by ozone and Fe₂O₃.² This study can compare the efficacy in PFAS molecule degradation between Fe₂O₃, SiO₂, pure-Si MFI (S-1), pure-Si zeolite Beta (Si-Beta), and Al-free zeolite Beta synthesized by treating Al-Beta zeolites in concentrated nitric acid (de-Al-Beta). This study can determine the relative rates of degradation between Fe₂O₃ and various SiO₂ catalysts, to determine if reducible metal oxides like Fe₂O₃ are preferable to irreducible metal oxides and to demonstrate that the majority of the reactivity observed over Fe₂O₃@Si-zeolite catalysts reflects reactions occurring at the surface of Fe₂O₃ particles and not along the pore walls of the molecular sieves. Comparisons between amorphous SiO₂, S-1, Si-Beta, and de-Al-Beta can determine if there are any benefits from either increased hydrophobicity (Si-Beta-F vs. de-Al-Beta) or increased microporosity (S-1 and Si-Beta vs. SiO₂) on PFAS decomposition with ozone over SiO₂ in the absence of Fe₂O₃. Fresh and used catalysts can be characterized by XRD, N₂ physisorption, inductively coupled plasma optical emission spectrometry (ICP-OES), and diffuse-reflectance UV-visible spectroscopy. Filtration tests can be performed after reaction to determine if active species have leached into solution and are capable of converting reactants in the absence of solid particles, catalyst reuse tests, and ICP-OES analyses of the solution phase in order to evince if Fe atoms leach into solution and demonstrate the stability of the catalyst through multiple batch reactions.

Studies of additional long chain PFAS molecules, common contaminants, and beneficial anions: After studies of PFOA, the kinetic studies can be extended to PFSAs with and without ether linkages (PFOS and 6:2 chlorinated polyfluorinated ether sulfonate acid (F-53B), respectively) (TABLE 1). By comparing degradation rates and kinetics among these three molecules, this study can determine the role of intramolecular ether linkages and the identity of the end groups (carboxylic acid or sulfonic acid) on catalytic degradation of C₈₊ PFAS molecules in the presence of ozone. Extensions of this portion of the project include testing the degradation of a Co PFCA (perfluorononanoic acid (PFNA)) and PFAS molecule precursors that are not fully perfluorinated, including 5:3 fluorotelomer carboxylic acid (5:3 FTCA) and 6:2 fluorotelomer sulfonic acid (6:2 FTSA).

After developing mechanistic insights into the decomposition kinetics of PFAS molecules, and in order to simulate effluent from NF/RO¹⁴⁵ processes and other waste streams that contain common ionic solutes in addition to PFAS molecules, the study can explore the impact of including relevant concentrations of NaCl, Na₂SO₄, NaHCO₃, NaNO₃ (100 mg/L)¹⁴⁶ and natural organic matter (NOM, which can be simulated as humic acid, 25 mg/L)¹⁴⁷⁻¹⁴⁹ on PFAS degradation rates, as these may scavenge the oxidants, block catalyst pores, or compete for surface active sites, resulting in reduced PFAS decomposition rates or catalyst stability with time on stream.¹⁴⁵ Extensions of these experiments can explore the benefits of including persulfate in reactant mixtures, particularly given previously reported benefits for the decomposition of PFSA molecules² that potentially result from the increased favorability of direct electron transfer to sulfate radicals (that result from persulfate decomposition) relative to direct electron transfer to hydroxyl radicals.⁷¹

Kinetic studies of short-chain PFAS molecules: It is expected that facile decomposition of C₈₊ PFAS molecules results in the formation of recalcitrant, short-chain PFAS molecules that may require elevated temperatures to further decompose. These molecules can be detected by LC-MS, UPLC-MS, and NMR, and then their decomposition kinetics can be further studied using the same methods outlined above. The study can determine whether slightly supra-ambient temperatures (30-50° C.) are sufficient to overcome the activation barriers for the decomposition of short-chain (C₄-C₅) PFAS molecules and whether these decomposition reactions are surface-catalyzed. Dramatic differences in either observed kinetics or inhibition by tert-butanol can demonstrate whether degradation of smaller PFAS molecules occurs via a similar mechanism to that for degradation of C₈₊ PFAS molecules, suggesting higher temperatures are required for short-chain PFAS molecule degradation, or if the kinetics are distinct, suggesting a different mechanism of catalytic ozonation and perhaps different design criteria for improved C<7 PFAS molecule degradation catalysts. Short-chain PFAS molecules initially considered can include C₄ and C₅ PFCAs with and without ether linkages (PFBA and GenX, respectively, TABLE 1), a C₄ PFSA (PFBS), and 1,1,1,2,2,3,3-heptafluoro-3-(1,2,2,2-tetrafluoroethoxy) propane (E1), a C₅ molecule with an ether linkage, one C—H bond but no acid group. Pentafluoropropionic acid (PFPrA) and other short chain PFAS molecules that are not fully perfluorinated can also be considered.

Synthesis of Hydrophobic, Zeolite Encapsulated Fe₂O₃ Catalysts

Hydrothermal synthesis of Fe-containing zeolites: Routes to synthesize zeolites containing isolated Fe atoms in pure-SiO₂ frameworks or Fe ion-exchanged for framework protons are well-known, 150,151 and emerging synthetic approaches have been reported for encapsulation of Fe₂O₃ within hydrophilic MFI zeolites.¹⁵² Previous studies on the synthesis of zeolites and pure SiO₂ molecular sieves of varied hydrophobicity^{90,153-156} can be used to determine whether carefully controlled synthetic approaches that generate nearly monodisperse Fe₂O₃ clusters within zeolites can be applied to encapsulate Fe₂O₃ within the pores of hydrophobic, Al-free Beta or MFI zeotypes. Hydrothermal synthesis of low Al or Al-free zeolites, particularly in fluoride-containing synthesis media, results in zeolites with low polarity, reflected in decreased volumetric water uptakes.^{153,157} These precepts have been used previously to reduce intraporous concentrations of water during aqueous glucose isomerization catalysis, resulting in order of magnitude higher isomerization rates in hydrophobic molecular sieves compared to their hydrophilic analogs (FIG. 5)^{90,153} due to reduced entropic penalties for solvent reorganization at isomerization transition states.⁹⁰

Here, the study aims to synthesize Fe₂O₃ clusters in Al-MFI zeolites of high Si/Al ratios (≥30) by following reported protocols,¹⁵² while also exploring possibilities for further increasing hydrophobicity by encapsulating of Fe₂O₃ clusters within Al-free zeolites. The latter aim can be achieved by including Fe₂O₃ within Si-Beta-F synthesis mixtures, as has been done previously to generate SnO₂ particles within the pores of Si-Beta-F.¹⁵⁸ Comparison materials can include Fe₂O₃/SiO₂ mixed oxides, and Fe₂O₃ particles on the external surfaces of Si-Beta-F crystallites, produced by incipient wetness impregnation of uncalcined Si-Beta-F zeolites with pores occluded by organic structure-directing agents.¹⁵⁸

Post-synthetic modification of zeolites to decrease polarity: Prior literature reports have demonstrated benefits on hydrothermal stability and crystal hydrophobicity of grafting long chain organosilanes (e.g., octadecyltrichlorosilane) on the external crystal surfaces of zeolites.¹⁵⁹ Through these post-synthetic grafting protocols, hydrophobic zeolites containing intracrystalline Fe₂O₃ clusters can be generated starting from Fe₂O₃@Al-MFI or Fe₂O₃@Si-Beta catalysts.

Catalytic testing of zeolite-encapsulated and hydrophobic zeolite-encapsulated Fe₂O₃ materials: All materials generated can be tested according to the procedures described above. Their reactivity can be compared to that of bulk iron oxide, with the expectation that apolar PFAS and ozone reactants may preferentially adsorb within hydrophobic pores compared to water, resulting in locally higher PFAS concentrations (FIG. 3) and elevated PFAS decomposition activity over intracrystalline Fe₂O₃ clusters compared to bulk Fe₂O₃. This enhancement in reactivity can allow for the decomposition of problematic short-chain PFAS molecules at ambient temperature.

Prepare, Characterize, and Performance Evaluate Fe₂O₃-PVDF Membranes

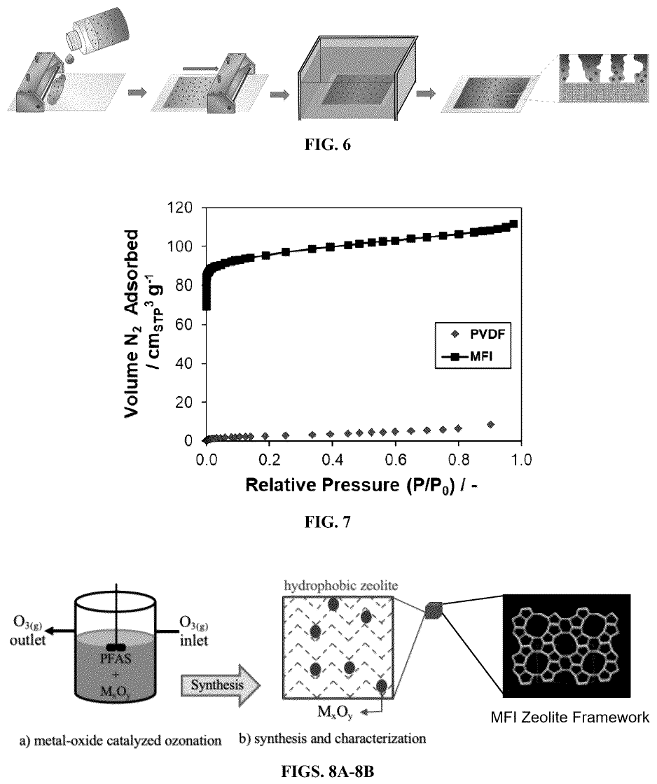

Fabrication of iron oxide and iron-incorporated zeolite PVDF membranes: PVDF membranes can be synthesized using the non-solvent induced phase separation (NIPS) method (FIG. 6). The dope casting solution can be made by mixing DMAc as the solvent, polyvinylpyrrolidone (PVP) as the pore-forming agent,^{108,160} LiCl as a pore-forming and viscosity control agent,^{108,160} PVDF powder (example: Solvay, Solef 1015), and various amounts of Fe₂O₃ or iron-incorporated zeolites. Typical loadings of iron oxide in PVDF dope solutions are up to 2.0 wt %.^{107,108} Control PVDF membranes can be made without iron oxide. The water content in each of these items is critically important for successful membrane formation, so the DMAc can be anhydrous and the PVP, LiCl, PVDF, and Fe₂O₃ particles can be vacuum dried and stored in a desiccator. The dope solution can be mixed overnight and allowed to settle for ≥4 h to degas. The dope solution can be poured onto the non-woven fabric and a doctor blade can be used to spread the dope solution evenly on the fabric. The cast polymer on fabric can be immediately immersed into a water (non-solvent) bath for precipitation. The doctor blade can be adjusted to study the effect of membrane thickness on catalytic performance. The study can probe whether the pores of zeolites incorporated in PVDF membranes are accessible by measuring N₂ isotherms of membrane-zeolite composites, as micropore volumes of PVDF membranes are much lower than those of zeolites (FIG. 7).

Characterize the PVDF membranes: Membrane surface and cross-section morphology can be characterized by scanning electron microscopy (SEM). Membrane pore size can be characterized by SEM using the imaging processing software ImageJ.¹⁶¹⁻¹⁶³ Porosity can be characterized gravimetrically using kerosene or isopropanol as the wetting solvent.¹⁶⁴⁻¹⁶⁷ Surface roughness can be characterized using tapping mode atomic force microscopy (AFM). X-ray photoelectron spectroscopy (XPS) and energy-dispersive X-ray spectroscopy (EDX) can be used to verify iron oxide and iron-incorporated zeolites are present on the membrane surface. Membrane wettability can be quantified via static water contact angle measurements using a contact angle goniometer. Membrane surface charge can be evaluated using a streaming/zeta potential analyzer. Leaching tests can be performed to ensure the Fe₂O₃ or iron-incorporated zeolites do not leach out of the membrane. Membranes can be immersed in DI water and DI water with ozone for extended periods to confirm the membranes are stable in the presence of ozone. Membranes can also be exposed to typical basic (~pH 11.0 with NaOH) and acidic (~pH 2.0 with HNO₃ or H₃PO₄) cleaning solutions. Water samples can be taken periodically and their iron content can be measured by ICP-OES.¹⁰⁹

Performance evaluate the PVDF membranes: The water permeance of the synthesized membranes can be measured by filtering DI water in a dead-end filtration cell. Rejection performance can be measured by challenging the membrane using a suspended solids solution made from 500 ppm polystyrene (PS) beads.¹⁶⁸ Various PS bead sizes can be used to confirm the pore size results. The concentration of PS beads in the feed and permeate can be measured using UV-vis spectrophotometry.

The effect of ozone itself on the stability of pristine, Fe₂O₃-containing, and iron-incorporated zeolite-containing membranes can be determined. Ozone at various concentrations (at least 1.0 mg/L) can be introduced to the feed solution just before the membrane unit^{119,122,169} to expose the membranes to ozone during DI water permeance tests and the permeate flowrate can be monitored over time.^{126,130} If the water permeation rates drastically increase, then the membrane can be considered damaged, which is undesirable. Membranes can be visualized via SEM to further support degradation if seen in the water permeance tests. As stated in the background section, ozone has been used numerous times with PVDF membranes with no adverse effects,^{113,114} so ozone damage is unlikely to occur.

The catalytic activity as a function of Fe₂O₃ and iron-incorporated zeolite concentration in the dope solution can be determined to find the most active Fe₂O₃ loading in the membrane. Additionally, the study can determine whether the iron-loaded PVDF membranes have different PFAS degradation products than loose iron catalyst in solution. The degradation mechanism may be different due to the extended residence time of the PFAS molecules near the external surface of the zeolite crystals relative to the catalysts in solution due to the presence of the membrane. This could result in an increased likelihood of readsorption and further reaction of reactants and primary degradation products over the iron-containing catalysts embedded within the membrane, similar to the impact of increasing intracrystalline residence time in zeolite-catalyzed homologation,¹⁷⁰ isomerization,¹⁷¹ and oligomerization reactions.¹⁷² PFAS degradation tests can first be done, similar to the tests described above, by contacting a loose (not sealed for permeation and rejection tests) membrane with a PFAS solution (see TABLE 1 for PFAS molecules) with and without ozone. PFAS concentrations can be in the μg/L range, as that is the level expected from concentrated solutions.¹⁶ Finally, PFAS degradation can be determined as a function of flowrate (throughput through the membrane) and ozone concentration using dead-end mode filtration. The flowrate through the membrane can be controlled by changing the applied pressure and the ozone concentration can be controlled by changing the input power of the ozone generator. After developing mechanistic insights into the decomposition kinetics of PFAS molecules, the study can explore the impact of common ions and NOM typically found in water.

### Example 2: Degradation of Per- and Polyfluoroalkyl Substances (PFAS) in Water Via Catalyzed Ozonolysis Over Metal Oxides

In 2022, the EPA advisory limit for PFOA was lowered from 70 ppt to 0.004 ppt.¹ A higher exposure to PFOA may result in a higher risk of cancers and decreased immune efficiency.² Current PFOA treatment strategies include reverse osmosis, incineration, activated carbon filtration, electrochemical methods, advanced oxidation processes, and photocatalysis

Ozonation is proven to decompose contaminants.³ As such, it could be a feasible alternative for water treatment centers. Heterogeneously catalyzed ozonation can decompose select PFAS with up to 98% removal efficiency.³

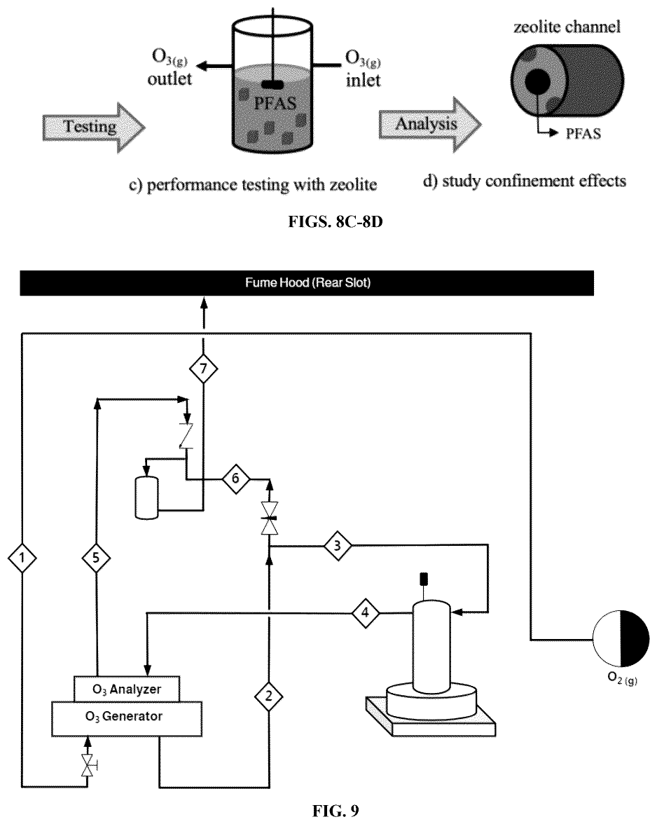

A study was conducted which attempted to substantially increase decomposition rates of PFOA in the presence of molecular ozone and MₓO_{y}. FIGS. 8A-8D show the general setup of the study. First, metal-oxide catalyzed ozonation was studied. Next, a catalyst including a metal oxide encapsulated in a zeolite was synthesized and characterized. Next, this zeolite catalyst was performance tested. Finally, confinement effects were studied.

The setup of the gaseous ozonation reactor used is shown in FIG. 9. The reactor was charged with 30 mg of catalyst (Fe₂O₃, MnO₂, or CuO) and 30 mg of SiO₂. Molecular ozone (O₃) was bubbled through the reactor at a rate of 100 mL/min. The reactor was run at varying temperatures between 25-90° C. with a stir rate of 500 RPM. Sample analysis was conducted via LC-MS using EPA method 1633.

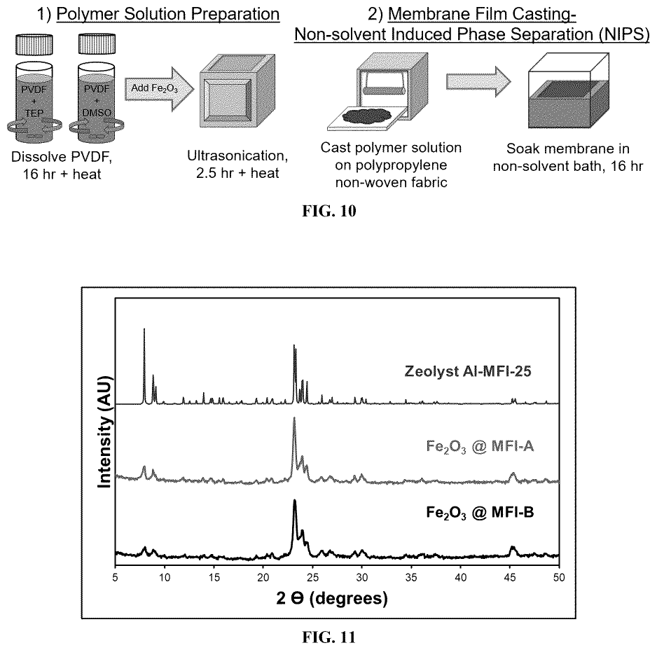

FIG. 10 shows the process used for PVDF-Fe₂O₃ catalytic membrane fabrication. In the polymer solution preparation phase, PVDF is dissolved in a solvent (e.g., TEP or DMSO) and stirred for 16 hours under heat. The metal oxide (i.e., Fe₂O₃) is then added, and the solution is ultrasonicated for 2.5 hours under heat. In the membrane film casting phase, the PVDF solution is cast on polypropylene non-woven fabric and soaked in a non-solvent bath for 16 hours to induce phase separation. Additionally, metal oxide catalysts encapsulated in zeolites were also synthesized.

FIG. 11 shows that initial synthesis of Fe₂O₃ encapsulated in MFI zeolite appears successful. The resulting diffractograms from XRD analysis for two synthesized batches of Fe₂O₃@MFI compared to Zeolyst MFI (Si/Al=25).

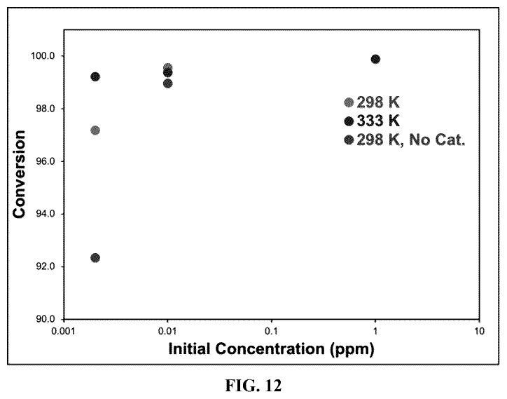

FIG. 12 depicts conversion as a function of starting concentration of PFOA. These reactions are performed under standard operating conditions at varying temperatures 25-60° C. without and with catalyst (Fe₂O₃). Conversions up to 99% are achievable at low initial concentrations of PFOA.

A proposed decomposition pathway was deduced from the reaction data. It is likely that the mechanism involved hydroxyl radicals, metal-oxygen radical complexes, and oxygen radicals.⁵ In general, ozone decomposition has a pathway of SCHEME 2, and hydroxyl radial initiation by Fe₂O₃ is proposed to have a pathway of SCHEME 3. Thus, hydroxyl radical-mediated oxidation is proposed to have a pathway of SCHEME 4.

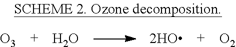

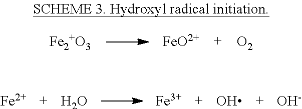

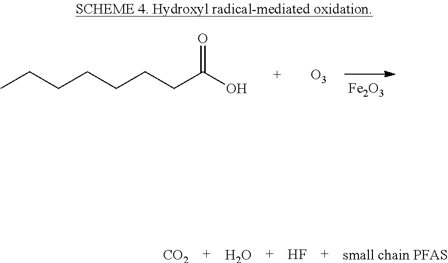

This study found that Fe₂O₃ was more effective than CuO and MnO₂ in the catalyzed ozonation of PFOA for the conditions tested. Increased temperatures were beneficial to PFOA degradation, which is consistent with catalytic degradation rather than absorption of the PFOA on the catalyst. Future studies can explore ozonation byproducts to determine the degree of PFOA conversion and develop a kinetic model for catalyzed ozonation in selected buffer solutions with each MₓO_{y}.

### Example Aspects

Example 1: A method for chemically degrading per- and polyfluorinated substances (PFAS), comprising contacting a metal oxide encapsulated in a zeolite with an aqueous PFAS and ozone.

Example 2: The method of any examples herein, particularly Example 1, wherein the metal oxide comprises Fe₂O₃, CuO, MnO₂, TiO₂, ZnO, CeO₂, V₂O₅ or any combination thereof.

Example 3: The method of any examples herein, particularly Examples 1-2, wherein the zeolite is hydrophobic.

Example 4: The method of any examples herein, particularly Example 3, wherein the zeolite comprises a Beta zeolite, an MFI zeolite, an LTA zeolite, an FAU zeolite, an MOR zeolite, an FER zeolite, a CHA zeolite, a mesoporous material (e.g., SBA-15 or MCM-41), or any combination thereof.

Example 5: The method of any examples herein, particularly Examples 1-4, wherein the zeolite has a pore diameter of from about 0.05 nm to about 1 nm.

Example 6: The method of any examples herein, particularly Examples 1-5, wherein the aqueous PFAS has a concentration of from about 10 ppm to about 5000 ppm.

Example 7: The method of any examples herein, particularly Examples 1-6, wherein the aqueous PFAS is in a naturally occurring body of water or a municipal water supply.

Example 8: The method of any examples herein, particularly Examples 1-7, further comprising heating the aqueous PFAS to a temperature of from about 50° C. to about 100° C.

Example 9: The method of any examples herein, particularly Examples 1-8, wherein contacting the metal oxide encapsulated in the zeolite with the aqueous PFAS and ozone occurs for from about 1 hour to about 48 hours.

Example 10: The method of any examples herein, particularly Examples 1-9, wherein the PFAS is chemically degraded to CO₂ and HF/F⁻.

Example 11: The method of any examples herein, particularly Example 10, wherein the PFAS is entirely chemically degraded to CO₂ and HF/F⁻.

Example 12: A method for chemically degrading PFAS, comprising contacting a membrane with PFAS and ozone, wherein the membrane is doped with a metal oxide.

Example 13: The method of any examples herein, particularly Example 12, wherein the metal oxide comprises Fe₂O₃, CuO, MnO₂, TiO₂, ZnO, CeO₂, V₂O₅ or any combination thereof.

Example 14: The method of any examples herein, particularly Examples 12-13, wherein the membrane is hydrophobic.

Example 15: The method of any examples herein, particularly Example 14, wherein the membrane comprises polyvinylidene fluoride (PVDF), polytetrafluoroethylene (PTFE), polyethylene (PE), polypropylene (PP) polysulfone (PSF), polyethersulfone (PES), polyacrylonitrile (PAN), cellulose acetate (CA), or any combination thereof.

Example 16: The method of any examples herein, particularly Examples 12-15, wherein the metal oxide has a concentration of from about 0.1 wt % to about 5 wt % in the membrane.

Example 17: The method of any examples herein, particularly Examples 12-16, wherein the aqueous PFAS has a concentration of from about 10 ppm to about 5000 ppm.

Example 18: The method of any examples herein, particularly Examples 12-17, wherein the aqueous PFAS is in a naturally occurring body of water or a municipal water supply.

Example 19: The method of any examples herein, particularly Examples 12-18, further comprising heating the aqueous PFAS to a temperature of from about 50° C. to about 100° C.

Example 20: The method of any examples herein, particularly Examples 12-19, wherein contacting the membrane with PFAS and ozone occurs for from about 1 hour to about 48 hours.

Example 21: The method of any examples herein, particularly Examples 12-20, wherein the PFAS is chemically degraded to CO₂ and HF/F⁻.

Example 22: The method of any examples herein, particularly Example 21, wherein the PFAS is entirely chemically degraded to CO₂ and HF/F⁻.

Example 23: A composition for chemical degradation of PFAS, comprising a membrane doped with a metal oxide encapsulated in a zeolite.

Example 24: The composition of any examples herein, particularly Example 23, wherein the membrane is hydrophobic.

Example 25: The composition of any examples herein, particularly Example 24, wherein the membrane comprises polyvinylidene fluoride (PVDF), polytetrafluoroethylene (PTFE), polyethylene (PE), polypropylene (PP) polysulfone (PSF), polyethersulfone (PES), polyacrylonitrile (PAN), cellulose acetate (CA), or any combination thereof.

Example 26: The composition of any examples herein, particularly Examples 23-25, wherein the metal oxide comprises Fe₂O₃, CuO, MnO₂, TiO₂, ZnO, CeO₂, V₂O₅ or any combination thereof.

Example 27: The composition of any examples herein, particularly Examples 23-26, wherein the zeolite is hydrophobic.

Example 28: The composition of any examples herein, particularly Example 27, wherein the zeolite comprises a Beta zeolite, an MFI zeolite, an LTA zeolite, an FAU zeolite, an MOR zeolite, an FER zeolite, a CHA zeolite, a mesoporous material (e.g., SBA-15 or MCM-41), or any combination thereof.

Example 29: The composition of any examples herein, particularly Examples 23-28, wherein the zeolite has a pore diameter of from about 0.05 nm to about 1 nm.

Example 30: The composition of any examples herein, particularly Examples 23-29, wherein the metal oxide encapsulated in the zeolite has a concentration of from about 0.1 wt % to about 5 wt % in the membrane.

Example 31: A method for chemically degrading PFAS, comprising contacting the composition of any examples herein, particularly Examples 23-30 with aqueous PFAS and ozone.

Example 32: The method of any examples herein, particularly Example 31, wherein the aqueous PFAS has a concentration of from about 10 ppm to about 5000 ppm.

Example 33: The method of any examples herein, particularly Examples 31-32, wherein the aqueous PFAS is in a naturally occurring body of water or a municipal water supply. 136. Example 34: The method of any examples herein, particularly Examples 31-33, further comprising heating the aqueous PFAS to a temperature of from about 50° C. to about 100° C. 137. Example 35: The method of any examples herein, particularly Examples 31-34, wherein contacting the membrane with the composition occurs for from about 1 hour to about 48 hours.

Example 36: The method of any examples herein, particularly Examples 31-35, wherein the PFAS is chemically degraded to CO₂ and HF/F⁻.

Example 37: The method of any examples herein, particularly Example 36, wherein the PFAS is entirely chemically degraded to CO₂ and HF/F.

The following patents, applications and publications as listed below and throughout this document are hereby incorporated by reference in their entirety herein.

### REFERENCE LIST FOR EXAMPLE 1

(1) Kwiatkowski, C. F.; Andrews, D. Q.; Birnbaum, L. S.; Bruton, T. A.; DeWitt, J. C.; Knappe, D. R. U.; Maffini, M. V.; Miller, M. F.; Pelch, K. E.; Reade, A.; et al. Scientific Basis for Managing PFAS as a Chemical Class. Environmental Science & Technology Letters 2020, 7, 532-543
(2) Franke, V.; Dorothea Schäfers, M.; Lindberg, J. J.; Ahrens, L. Removal of per- and polyfluoroalkyl substances (PFASs) from tap water using heterogeneously catalyzed ozonation. Environmental Science: Water Research & Technology 2019, 5, 1887-1896
(3) Boo, C.; Wang, Y.; Zucker, I.; Choo, Y.; Osuji, C. O.; Elimelech, M. High Performance Nanofiltration Membrane for Effective Removal of Perfluoroalkyl Substances at High Water Recovery. Environmental Science & Technology 2018, 52, 7279-7288
(4) Le, T.; Jamshidi, E.; Beidaghi, M.; Esfahani, M. R. Functionalized-MXene Thin-Film Nanocomposite Hollow Fiber Membranes for Enhanced PFAS Removal from Water. ACS Applied Materials & Interfaces 2022, 14, 25397-25408
(5) Tow, E. W.; Ersan, M. S.; Kum, S.; Lee, T.; Speth, T. F.; Owen, C.; Bellona, C.; Nadagouda, M. N.; Mikelonis, A. M.; Westerhoff, P.; et al. Managing and treating per- and polyfluoroalkyl substances (PFAS) in membrane concentrates. AWWA Water Science 2021, 3, e1233
(6) Mastropietro, T. F.; Bruno, R.; Pardo, E.; Armentano, D. Reverse osmosis and nanofiltration membranes for highly efficient PFASs removal: overview, challenges and future perspectives. Dalton Transactions 2021, 50, 5398-5410
(7) Liu, C.; Zhao, X.; Faria, A. F.; Deliz Quiñones, K. Y.; Zhang, C.; He, Q.; Ma, J.; Shen, Y.; Zhi, Y. Evaluating the efficiency of nanofiltration and reverse osmosis membrane processes for the removal of per- and polyfluoroalkyl substances from water: A critical review. Separation and Purification Technology 2022, 302, 122161
(8) Xiong, J.; Hou, Y.; Wang, J.; Liu, Z.; Qu, Y.; Li, Z.; Wang, X. The rejection of perfluoroalkyl substances by nanofiltration and reverse osmosis: influencing factors and combination processes. Environmental Science: Water Research & Technology 2021, 7, 1928-1943
(9) Crone, B. C.; Speth, T. F.; Wahman, D. G.; Smith, S. J.; Abulikemu, G.; Kleiner, E. J.; Pressman, J. G. Occurrence of per- and polyfluoroalkyl substances (PFAS) in source water and their treatment in drinking water. Critical Reviews in Environmental Science and Technology 2019, 49, 2359-2396
(10) Gagliano, E.; Sgroi, M.; Falciglia, P. P.; Vagliasindi, F. G. A.; Roccaro, P. Removal of poly- and perfluoroalkyl substances (PFAS) from water by adsorption: Role of PFAS chain length, effect of organic matter and challenges in adsorbent regeneration. Water Research 2020, 171, 115381
(11) Ateia, M.; Maroli, A.; Tharayil, N.; Karanfil, T. The overlooked short- and ultrashort-chain poly- and perfluorinated substances: A review. Chemosphere 2019, 220, 866-882
(12) Hogue, C. US EPA deems two GenX PFAS chemicals more toxic than PFOA. American Chemical Society, 2021. (accessed 2021 10-28).
(13) EPA, U. Technical Fact Sheet: Drinking Water Health Advisories for Four PFAS (PFOA, PFOS, GenX chemicals, and PFBS). US Environmental Protection Agency: 2022.
(14) EPA, U. Per- and Polyfluoroalkyl Substances National Primary Drinking Water Regulation. 2023; Vol. 40 CFR Parts 141 and 142.
(15) Barbo, N.; Stoiber, T.; Naidenko, O. V.; Andrews, D. Q. Locally caught freshwater fish across the United States are likely a significant source of exposure to PFOS and other perfluorinated compounds. Environmental Research 2023, 220, 115165
(16) Ateia, M.; Alsbaiee, A.; Karanfil, T.; Dichtel, W. Efficient PFAS Removal by Amine-Functionalized Sorbents: Critical Review of the Current Literature. Environmental Science & Technology Letters 2019, 6, 688-695
(17) Rahman, M. F.; Peldszus, S.; Anderson, W. B. Behaviour and fate of perfluoroalkyl and polyfluoroalkyl substances (PFASs) in drinking water treatment: a review. Water Research 2014, 50, 318-340
(18) Wang, R.; Lin, Z.-W.; Klemes, M. J.; Ateia, M.; Trang, B.; Wang, J.; Ching, C.; Helbling, D. E.; Dichtel, W. R. A Tunable Porous β-Cyclodextrin Polymer Platform to Understand and Improve Anionic PFAS Removal. ACS Central Science 2022, 8, 663-669
(19) Gutiérrez, A.; Maletta, A.; Aparicio, S.; Atilhan, M. A theoretical study of low concentration per- and polyfluoroalkyl substances (PFAS) remediation from wastewater by novel hydrophobic deep eutectic solvents (HDES) extraction agents. Journal of Molecular Liquids 2023, 383, 122101
(20) Li, H.; Junker, A. L.; Wen, J.; Ahrens, L.; Sillanpää, M.; Tian, J.; Cui, F.; Vergeynst, L.; Wei, Z. A recent overview of per- and polyfluoroalkyl substances (PFAS) removal by functional framework materials. Chemical Engineering Journal 2023, 452, 139202
(21) Lu, J.; Lu, H.; Liang, D.; Feng, S.; Li, Y.; Li, J. A review of the occurrence, monitoring, and removal technologies for the remediation of per- and polyfluoroalkyl substances (PFAS) from landfill leachate. Chemosphere 2023, 332, 138824
(22) Smaili, H.; Ng, C. Adsorption as a remediation technology for short-chain per- and polyfluoroalkyl substances (PFAS) from water-a critical review. Environmental Science: Water Research & Technology 2023, 9, 344-362
(23) Liu, F.; Jiang, S.; You, S.; Liu, Y. Recent advances in electrochemical decontamination of perfluorinated compounds from water: a review. Frontiers of Environmental Science & Engineering 2022, 17, 18
(24) McGarr, J. T.; Mbonimpa, E. G.; McAvoy, D. C.; Soltanian, M. R. Fate and Transport of Per- and Polyfluoroalkyl Substances (PFAS) at Aqueous Film Forming Foam (AFFF) Discharge Sites: A Review. Soil Systems 2023, 7, 53
(25) Zeidabadi, F. A.; Esfahani, E. B.; Mohseni, M. Effects of water matrix on per- and polyfluoroalkyl substances (PFAS) treatment: Physical-separation and degradation processes-A review. Journal of Hazardous Materials Advances 2023, 10, 100322
(26) Mirabediny, M.; Sun, J.; Yu, T. T.; Åkermark, B.; Das, B.; Kumar, N. Effective PFAS degradation by electrochemical oxidation methods-recent progress and requirement. Chemosphere 2023, 321, 138109
(27) Li, Z.; Luo, Z.-M.; Huang, Y.; Wang, J.-W.; Ouyang, G. Recent trends in degradation strategies of PFOA/PFOS substitutes. Chemosphere 2023, 315, 137653
(28) Khan, M. Y.; So, S.; da Silva, G. Decomposition kinetics of perfluorinated sulfonic acids. Chemosphere 2020, 238, 124615
(29) Trojanowicz, M.; Bojanowska-Czajka, A.; Bartosiewicz, I.; Kulisa, K. Advanced Oxidation/Reduction Processes treatment for aqueous perfluorooctanoate (PFOA) and perfluorooctanesulfonate (PFOS)—A review of recent advances. Chemical Engineering Journal 2018, 336, 170-199
(30) Cui, J.; Gao, P.; Deng, Y. Destruction of Per- and Polyfluoroalkyl Substances (PFAS) with Advanced Reduction Processes (ARPs): A Critical Review. Environmental Science & Technology 2020, 54, 3752-3766
(31) Merino, N.; Qu, Y.; Deeb, R. A.; Hawley, E. L.; Hoffmann, M. R.; Mahendra, S. Degradation and Removal Methods for Perfluoroalkyl and Polyfluoroalkyl Substances in Water. Environmental Engineering Science 2016, 33, 615-649
(32) Krause Max, J.; Thoma, E.; Sahle-Damesessie, E.; Crone, B.; Whitehill, A.; Shields, E.; Gullett, B. Supercritical Water Oxidation as an Innovative Technology for PFAS Destruction. Journal of Environmental Engineering 2022, 148, 05021006
(33) Trang, B.; Li, Y.; Xue, X.-S.; Ateia, M.; Houk, K. N.; Dichtel, W. R. Low-temperature mineralization of perfluorocarboxylic acids. Science 2022, 377, 839-845
(34) Dai, X.; Xie, Z.; Dorian, B.; Gray, S.; Zhang, J. Comparative study of PFAS treatment by UV, UV/ozone, and fractionations with air and ozonated air. Environmental Science: Water Research & Technology 2019, 5, 1897-1907
(35) Bentel, M. J.; Yu, Y.; Xu, L.; Li, Z.; Wong, B. M.; Men, Y.; Liu, J. Defluorination of Per- and Polyfluoroalkyl Substances (PFASs) with Hydrated Electrons: Structural Dependence and Implications to PFAS Remediation and Management. Environmental Science & Technology 2019, 53, 3718-3728
(36) Liu, J.; Qu, R.; Wang, Z.; Mendoza-Sanchez, I.; Sharma, V. K. Thermal- and photo-induced degradation of perfluorinated carboxylic acids: Kinetics and mechanism. Water Research 2017, 126, 12-18
(37) Wang, S.; Yang, Q.; Chen, F.; Sun, J.; Luo, K.; Yao, F.; Wang, X.; Wang, D.; Li, X.; Zeng, G. Photocatalytic degradation of perfluorooctanoic acid and perfluorooctane sulfonate in water: A critical review. Chemical Engineering Journal 2017, 328, 927-942
(38) Xu, B.; Ahmed, M. B.; Zhou, J. L.; Altaee, A.; Wu, M.; Xu, G. Photocatalytic removal of perfluoroalkyl substances from water and wastewater: Mechanism, kinetics and controlling factors. Chemosphere 2017, 189, 717-729
(39) Cheng, J.; Vecitis, C. D.; Park, H.; Mader, B. T.; Hoffmann, M. R. Sonochemical Degradation of Perfluorooctane Sulfonate (PFOS) and Perfluorooctanoate (PFOA) in Groundwater: Kinetic Effects of Matrix Inorganics. Environmental Science & Technology 2010, 44, 445-450
(40) Shende, T.; Andaluri, G.; Suri, R. P. S. Kinetic model for sonolytic degradation of non-volatile surfactants: Perfluoroalkyl substances. Ultrasonics Sonochemistry 2019, 51, 359-368
(41) Lei, Y.-J.; Tian, Y.; Sobhani, Z.; Naidu, R.; Fang, C. Synergistic degradation of PFAS in water and soil by dual-frequency ultrasonic activated persulfate. Chemical Engineering Journal 2020, 388, 124215
(42) Barisci, S.; Suri, R. Electrooxidation of short and long chain perfluorocarboxylic acids using boron doped diamond electrodes. Chemosphere 2020, 243, 125349
(43) Fang, C.; Sobhani, Z.; Niu, J.; Naidu, R. Removal of PFAS from aqueous solution using PbO2 from lead-acid battery. Chemosphere 2019, 219, 36-44
(44) Soriano, A.; Gorri, D.; Urtiaga, A. Efficient treatment of perfluorohexanoic acid by nanofiltration followed by electrochemical degradation of the NF concentrate. Water Research 2017, 112, 147-156
(45) Wang, Y.; Pierce, R. D.; Shi, H.; Li, C.; Huang, Q. Electrochemical degradation of perfluoroalkyl acids by titanium suboxide anodes. Environmental Science: Water Research & Technology 2020, 6, 144-152
(46) Lee, Y.-C.; Li, Y.-f.; Chen, M.-J.; Chen, Y.-C.; Kuo, J.; Lo, S.-L. Efficient decomposition of perfluorooctanic acid by persulfate with iron-modified activated carbon. Water Research 2020, 174, 115618
(47) Lee, Y.-C.; Lo, S.-L.; Kuo, J.; Huang, C.-P. Promoted degradation of perfluorooctanic acid by persulfate when adding activated carbon. Journal of Hazardous Materials 2013, 261, 463-469
(48) Albert, K.; Hsieh, P.-Y.; Chen, T.-H.; Hou, C.-H.; Hsu, H.-Y. Diatom-assisted biomicroreactor targeting the complete removal of perfluorinated compounds. Journal of Hazardous Materials 2020, 384, 121491
(49) Dombrowski, P. M.; Kakarla, P.; Caldicott, W.; Chin, Y.; Sadeghi, V.; Bogdan, D.; Barajas-Rodriguez, F.; Chiang, S.-Y. Technology review and evaluation of different chemical oxidation conditions on treatability of PFAS. Remediation Journal 2018, 28, 135-150
(50) Trojanowicz, M.; Bartosiewicz, I.; Bojanowska-Czajka, A.; Szreder, T.; Bobrowski, K.; Nałęcz-Jawecki, G.; Męczyńska-Wielgosz, S.; Nichipor, H. Application of ionizing radiation in decomposition of perfluorooctane sulfonate (PFOS) in aqueous solutions. Chemical Engineering Journal 2020, 379, 122303
(51) Stratton, G. R.; Dai, F.; Bellona, C. L.; Holsen, T. M.; Dickenson, E. R. V.; Mededovic Thagard, S. Plasma-Based Water Treatment: Efficient Transformation of Perfluoroalkyl Substances in Prepared Solutions and Contaminated Groundwater. Environmental Science & Technology 2017, 51, 1643-1648
(52) Saleem, M.; Biondo, O.; Sretenović, G.; Tomei, G.; Magarotto, M.; Pavarin, D.; Marotta, E.; Paradisi, C. Comparative performance assessment of plasma reactors for the treatment of PFOA; reactor design, kinetics, mineralization and energy yield. Chemical Engineering Journal 2020, 382, 123031
(53) Cheng, X.; Li, P.; Liu, W.; Luo, C.; Wu, D.; Zhou, W.; Zheng, L.; Zhu, X.; Liang, H. Activation of peroxymonosulfate by metal oxide nanoparticles for mitigating organic membrane fouling in surface water treatment. Separation and Purification Technology 2020, 246, 116935
(54) Long, M.; Donoso, J.; Bhati, M.; Elias, W. C.; Heck, K. N.; Luo, Y.-H.; Lai, Y. S.; Gu, H.; Senftle, T. P.; Zhou, C.; et al. Adsorption and Reductive Defluorination of Perfluorooctanoic Acid over Palladium Nanoparticles. Environmental Science & Technology 2021, 55, 14836-14843
(55) Loeb, B. L.; Thompson, C. M.; Drago, J.; Takahara, H.; Baig, S. Worldwide Ozone Capacity for Treatment of Drinking Water and Wastewater: A Review. Ozone: Science & Engineering 2012, 34, 64-77
(56) Oneby, M. A.; Bromley, C. O.; Borchardt, J. H.; Harrison, D. S. Ozone Treatment of Secondary Effluent at U.S. Municipal Wastewater Treatment Plants. Ozone: Science & Engineering 2010, 32, 43-55
(57) Sigmon, C.; Shin, G.-A.; Mieog, J.; Linden, K. G. Establishing Surrogate-Virus Relationships for Ozone Disinfection of Wastewater. Environmental Engineering Science 2015, 32, 451-460
(58) de Wilt, A.; van Gijn, K.; Verhoek, T.; Vergnes, A.; Hoek, M.; Rijnaarts, H.; Langenhoff, A. Enhanced pharmaceutical removal from water in a three step bio-ozone-bio process. Water Research 2018, 138, 97-105
(59) Lin, A. Y.-C.; Panchangam, S. C.; Chang, C.-Y.; Hong, P. K. A.; Hsueh, H.-F. Removal of perfluorooctanoic acid and perfluorooctane sulfonate via ozonation under alkaline condition. Journal of Hazardous Materials 2012, 243, 272-277
(60) Phong Vo, H. N.; Ngo, H. H.; Guo, W.; Hong Nguyen, T. M.; Li, J.; Liang, H.; Deng, L.; Chen, Z.; Hang Nguyen, T. A. Poly- and perfluoroalkyl substances in water and wastewater: A comprehensive review from sources to remediation. Journal of Water Process Engineering 2020, 36, 101393
(61) Nawrocki, J.; Kasprzyk-Hordern, B. The efficiency and mechanisms of catalytic ozonation. Applied Catalysis B: Environmental 2010, 99, 27-42
(62) Takanabe, K.; Iglesia, E. Rate and selectivity enhancements mediated by OH radicals in the oxidative coupling of methane catalyzed by Mn/Na₂WO4/SiO₂. Angew. Chem. Int. Ed. 2008, 47, 7689-7693
(63) Takanabe, K.; Iglesia, E. Mechanistic Aspects and Reaction Pathways for Oxidative Coupling of Methane on Mn/Na2WO4/SiO2 Catalysts. J. Phys. Chem. C 2009, 113, 10131-10145
(64) Annamalai, L.; Liu, Y.; Deshlahra, P. Selective C—H Bond Activation via NOx Mediated Generation of Strong H-Abstractors. ACS Catal. 2019, 9, 10324-10338
(65) Thomas, R.; Jenkins, K.; Landale, B.; Trigger, G.; Holsen, T. M.; Dore, S.; Pope, D.; Wasielewski, J. Evaluation of PFAS treatment technology: Alkaline ozonation. Remediation Journal 2020, 30, 27-37
(66) Huang, J.; Wang, X.; Pan, Z.; Li, X.; Ling, Y.; Li, L. Efficient degradation of perfluorooctanoic acid (PFOA) by photocatalytic ozonation. Chemical Engineering Journal 2016, 296, 329-334
(67) Dhandapani, B.; Oyama, S. T. Gas phase ozone decomposition catalysts. Applied Catalysis B: Environmental 1997, 11, 129-166
(68) Legube, B.; Karpel Vel Leitner, N. Catalytic ozonation: a promising advanced oxidation technology for water treatment. Catalysis Today 1999, 53, 61-72
(69) Szajdzinska-Pietek, E.; Gebicki, J. L. Pulse radiolytic investigation of perfluorinated surfactants in aqueous solutions. Research on Chemical Intermediates 2000, 26, 897-912
(70) Arvaniti, O. S.; Stasinakis, A. S. Review on the occurrence, fate and removal of perfluorinated compounds during wastewater treatment. Science of The Total Environment 2015, 524-525, 81-92
(71) Vecitis, C. D.; Park, H.; Cheng, J.; Mader, B. T.; Hoffmann, M. R. Treatment technologies for aqueous perfluorooctanesulfonate (PFOS) and perfluorooctanoate (PFOA). Frontiers of Environmental Science & Engineering in China 2009, 3, 129-151
(72) Nzeribe, B. N.; Crimi, M.; Thagard, S. M.; Holsen, T. M. Physico-Chemical Processes for the Treatment of Per- And Polyfluoroalkyl Substances (PFAS): A review. Critical Reviews in Environmental Science and Technology 2019, 49, 866-915
(73) Javed, H.; Metz, J.; Eraslan, T. C.; Mathieu, J.; Wang, B.; Wu, G.; Tsai, A.-L.; Wong, M. S.; Alvarez, P. J. J. Discerning the Relevance of Superoxide in PFOA Degradation. Environmental Science & Technology Letters 2020, 7, 653-658
(74) Farrell, B. L.; Igenegbai, V. O.; Linic, S. A viewpoint on direct methane conversion to ethane and ethylene using oxidative coupling on solid catalysts. ACS Catal. 2016, 6, 4340-4346
(75) Kumar, A.; Song, K.; Liu, L.; Han, Y.; Bhan, A. Absorptive hydrogen scavenging for enhanced aromatics yield during non-oxidative methane dehydroaromatization on Mo/H-ZSM-5 catalysts. Angew. Chem. 2018, 130, 15803-15808
(76) Tinberg, C. E.; Lippard, S. J. Dioxygen activation in soluble methane monooxygenase. Acc. Chem. Res. 2011, 44, 280-288
(77) Faiz, F.; Baxter, G.; Collins, S.; Sidiroglou, F.; Cran, M. Polyvinylidene fluoride coated optical fibre for detecting perfluorinated chemicals. Sensors and Actuators B: Chemical 2020, 312, 128006
(78) Chen, N. Y. Hydrophobic properties of zeolites. The Journal of Physical Chemistry 1976, 80, 60-64
(79) Ochoa-Herrera, V.; Sierra-Alvarez, R. Removal of perfluorinated surfactants by sorption onto granular activated carbon, zeolite and sludge. Chemosphere 2008, 72, 1588-1593
(80) Krafft, M. P.; Riess, J. G. Selected physicochemical aspects of poly- and perfluoroalkylated substances relevant to performance, environment and sustainability-Part one. Chemosphere 2015, 129, 4-19
(81) Herrmann, S.; Iglesia, E. Elementary steps in acetone condensation reactions catalyzed by aluminosilicates with diverse void structures. J. Catal. 2017, 346, 134-153
(82) Gounder, R.; Iglesia, E. The Roles of Entropy and Enthalpy in Stabilizing Ion-Pairs at Transition States in Zeolite Acid Catalysis. Acc. Chem. Res. 2012, 45, 229-238
(83) Van den Bergh, M.; Krajnc, A.; Voorspoels, S.; Tavares, S. R.; Mullens, S.; Beurroies, I.; Maurin, G.; Mali, G.; De Vos, D. E. Highly Selective Removal of Perfluorinated Contaminants by Adsorption on All-Silica Zeolite Beta. Angew. Chem. Int. Ed. 2020, 59, 14086-14090
(84) Fujita, H.; Izumi, J.; Sagehashi, M.; Fujii, T.; Sakoda, A. Adsorption and decomposition of water-dissolved ozone on high silica zeolites. Water Research 2004, 38, 159-165
(85) Kim, B.-S.; Fujita, H.; Sakai, Y.; Sakoda, A.; Suzuki, M. Catalytic ozonation of an organophosphorus pesticide using microporous silicate and its effect on total toxicity reduction. Water Science and Technology 2002, 46, 35-41
(86) Bhattacharyya, D.; Van Dierdonck, T. F.; West, S. D.; Freshour, A. R. Two-phase ozonation of chlorinated organics. Journal of Hazardous Materials 1995, 41, 73-93
(87) Chen, W.; Bao, Y.; Li, X.; Huang, J.; Xie, J.; Li, L. Role of SiF groups in enhancing interfacial reaction of Fe-MCM-41 for pollutant removal with ozone. Journal of Hazardous Materials 2020, 393, 122387
(88) Lu, X.; Deng, S.; Wang, B.; Huang, J.; Wang, Y.; Yu, G. Adsorption behavior and mechanism of perfluorooctane sulfonate on nanosized inorganic oxides. Journal of Colloid and Interface Science 2016, 474, 199-205
(89) Gao, X.; Chorover, J. Adsorption of perfluorooctanoic acid and perfluorooctanesulfonic acid to iron oxide surfaces as studied by flow-through ATR-FTIR spectroscopy. Environmental Chemistry 2012, 9, 148-157
(90) Cordon, M. J.; Harris, J. W.; Vega-Vila, J. C.; Bates, J. S.; Kaur, S.; Gupta, M.; Witzke, M. E.; Wegener, E. C.; Miller, J. T.; Flaherty, D. W.; et al. The dominant role of entropy in stabilizing sugar isomerization transition states within hydrophobic zeolite pores. J. Am. Chem. Soc. 2018, 140, 14244-14266
(91) Zhang, C.; Yan, H.; Li, F.; Hu, X.; Zhou, Q. Sorption of short- and long-chain perfluoroalkyl surfactants on sewage sludges. Journal of Hazardous Materials 2013, 260, 689-699
(92) Zhao, L.; Ma, J.; Sun, Z.; Liu, H. Influencing mechanism of temperature on the degradation of nitrobenzene in aqueous solution by ceramic honeycomb catalytic ozonation. Journal of Hazardous Materials 2009, 167, 1119-1125
(93) Wang, X.; Li, Y.; Li, H.; Yang, C. Chitosan membrane adsorber for low concentration copper ion removal. Carbohydrate Polymers 2016, 146, 274-281
(94) Bhut, B. V.; Christensen, K. A.; Husson, S. M. Membrane chromatography: Protein purification from E. coli lysate using newly designed and commercial anion-exchange stationary phases. Journal of Chromatography A 2010, 1217, 4946-4957
(95) Boi, C.; Malavasi, A.; Carbonell, R. G.; Gilleskie, G. A direct comparison between membrane adsorber and packed column chromatography performance. Journal of Chromatography A 2020, 1612, 460629
(96) Li, Y.; Yeung, K. L. Polymeric catalytic membrane for ozone treatment of DEET in water. Catalysis Today 2019, 331, 53-59
(97) Zahid, M.; Rashid, A.; Akram, S.; Rehan, Z.; Razzaq, W. A comprehensive review on polymeric nano-composite membranes for water treatment. Journal of Membrane Science and Technology 2018, 8, 1-20
(98) Ng, L. Y.; Mohammad, A. W.; Leo, C. P.; Hilal, N. Polymeric membranes incorporated with metal/metal oxide nanoparticles: A comprehensive review. Desalination 2013, 308, 15-33
(99) Damodar, R. A.; You, S.-J.; Chou, H.-H. Study the self cleaning, antibacterial and photocatalytic properties of TiO₂ entrapped PVDF membranes. Journal of Hazardous Materials 2009, 172, 1321-1328
(100) Song, H.; Shao, J.; He, Y.; Liu, B.; Zhong, X. Natural organic matter removal and flux decline with PEG-TiO₂-doped PVDF membranes by integration of ultrafiltration with photocatalysis. Journal of Membrane Science 2012, 405-406, 48-56
(101) Hong, J.; He, Y. Polyvinylidene fluoride ultrafiltration membrane blended with nano-ZnO particle for photo-catalysis self-cleaning. Desalination 2014, 332, 67-75
(102) Ren, S.; Boo, C.; Guo, N.; Wang, S.; Elimelech, M.; Wang, Y. Photocatalytic Reactive Ultrafiltration Membrane for Removal of Antibiotic Resistant Bacteria and Antibiotic Resistance Genes from Wastewater Effluent. Environmental Science & Technology 2018, 52, 8666-8673
(103) Zhang, E.; Wang, L.; Zhang, B.; Xie, Y.; Wang, G. Enhanced photocatalytic performance of polyvinylidene fluoride membrane by doped CuFe₂O₄ nanocrystals for water treatment. Journal of Sol-Gel Science and Technology 2020, 93, 452-461
(104) Wang, T.; Wang, Z.; Wang, P.; Tang, Y. An integration of photo-Fenton and membrane process for water treatment by a PVDF@CuFe₂O₄ catalytic membrane. Journal of Membrane Science 2019, 572, 419-427
(105) Sun, M.; Zucker, I.; Davenport, D. M.; Zhou, X.; Qu, J.; Elimelech, M. Reactive, Self-Cleaning Ultrafiltration Membrane Functionalized with Iron Oxychloride Nanocatalysts. Environmental Science & Technology 2018, 52, 8674-8683
(106) Huang, Z.-H.; Zhang, X.; Wang, Y.-X.; Sun, J.-Y.; Zhang, H.; Liu, W.-L.; Li, M.-P.; Ma, X.-H.; Xu, Z.-L. Fe₃O₄/PVDF catalytic membrane treatment organic wastewater with simultaneously improved permeability, catalytic property and anti-fouling. Environmental Research 2020, 187, 109617
(107) Alpatova, A.; Meshref, M.; McPhedran, K. N.; Gamal El-Din, M. Composite polyvinylidene fluoride (PVDF) membrane impregnated with Fe₂O₃ nanoparticles and multiwalled carbon nanotubes for catalytic degradation of organic contaminants. Journal of Membrane Science 2015, 490, 227-235
(108) Tan, Y. H.; Goh, P. S.; Ismail, A. F.; Ng, B. C.; Lai, G. S. Decolourization of aerobically treated palm oil mill effluent (AT-POME) using polyvinylidene fluoride (PVDF) ultrafiltration membrane incorporated with coupled zinc-iron oxide nanoparticles. Chemical Engineering Journal 2017, 308, 359-369
(109) Yao, Y.; Lian, C.; Hu, Y.; Zhang, J.; Gao, M.; Zhang, Y.; Wang, S. Heteroatoms doped metal iron-polyvinylidene fluoride (PVDF) membrane for enhancing oxidation of organic contaminants. Journal of Hazardous Materials 2017, 338, 265-275
(110) Zhang, L.-P.; Liu, Z.; Faraj, Y.; Zhao, Y.; Zhuang, R.; Xie, R.; Ju, X.-J.; Wang, W.; Chu, L.-Y. High-flux efficient catalytic membranes incorporated with iron-based Fenton-like catalysts for degradation of organic pollutants. Journal of Membrane Science 2019, 573, 493-503
(111) Pinos-Vélez, V.; di Luca, C.; Crivoi, D. G.; Medina, F.; Dafinov, A. Catalytic Palladium-Based and Iron-Based Membrane Reactors: Novel Strategies of Synthesis. ACS Omega 2019, 4, 19818-19828
(112) Karimnezhad, H.; Navarchian, A. H.; Tavakoli Gheinani, T.; Zinadini, S. Amoxicillin removal by Fe-based nanoparticles immobilized on polyacrylonitrile membrane: Individual nanofiltration or Fenton reaction, vs. engineered combined process. Chemical Engineering Research and Design 2020, 153, 187-200
(113) Mansas, C.; Mendret, J.; Brosillon, S.; Ayral, A. Coupling catalytic ozonation and membrane separation: A review. Separation and Purification Technology 2020, 236, 116221
(114) Schmitt, A.; Mendret, J.; Roustan, M.; Brosillon, S. Ozonation using hollow fiber contactor technology and its perspectives for micropollutants removal in water: A review. Science of The Total Environment 2020, 729, 138664
(115) Rosman, N.; Salleh, W. N. W.; Mohamed, M. A.; Jaafar, J.; Ismail, A. F.; Harun, Z. Hybrid membrane filtration-advanced oxidation processes for removal of pharmaceutical residue. Journal of Colloid and Interface Science 2018, 532, 236-260
(116) Wang, X.; Davies, S. H.; Masten, S. J. Analysis of energy costs for catalytic ozone membrane filtration. Separation and Purification Technology 2017, 186, 182-187
(117) Wang, Z.; Chen, Z.; Chang, J.; Shen, J.; Kang, J.; Chen, Q. Fabrication of a low-cost cementitious catalytic membrane for p-chloronitrobenzene degradation using a hybrid ozonation-membrane filtration system. Chemical Engineering Journal 2015, 262, 904-912
(118) Guo, Y.; Xu, B.; Qi, F. A novel ceramic membrane coated with MnO2-Co3O4 nanoparticles catalytic ozonation for benzophenone-3 degradation in aqueous solution: Fabrication, characterization and performance. Chemical Engineering Journal 2016, 287, 381-389
(119) Park, H.; Choi, H. As(III) removal by hybrid reactive membrane process combined with ozonation. Water Research 2011, 45, 1933-1940
(120) Mansas, C.; Atfane-Karfane, L.; Petit, E.; Mendret, J.; Brosillon, S.; Ayral, A. Functionalized ceramic nanofilter for wastewater treatment by coupling membrane separation and catalytic ozonation. Journal of Environmental Chemical Engineering 2020, 8, 104043
(121) Harman, B. I.; Koseoglu, H.; Yigit, N. O.; Beyhan, M.; Kitis, M. The use of iron oxide-coated ceramic membranes in removing natural organic matter and phenol from waters. Desalination 2010, 261, 27-33
(122) Park, H.; Kim, Y.; An, B.; Choi, H. Characterization of natural organic matter treated by iron oxide nanoparticle incorporated ceramic membrane-ozonation process. Water Research 2012, 46, 5861-5870
(123) You, S.-H.; Tseng, D.-H.; Hsu, W.-C. Effect and mechanism of ultrafiltration membrane fouling removal by ozonation. Desalination 2007, 202, 224-230
(124) Yu, W.; Graham, N. J. D.; Fowler, G. D. Coagulation and oxidation for controlling ultrafiltration membrane fouling in drinking water treatment: Application of ozone at low dose in submerged membrane tank. Water Research 2016, 95, 1-10
(125) Wu, D.; Zhou, C.; Lu, G.; Zhou, Y.; Shen, Y. Simultaneous membrane fouling mitigation and emerging pollutant benzophenone-3 removal by electro-peroxone process. Separation and Purification Technology 2019, 227, 115715
(126) Jin, X.; Wang, W.; Wang, S.; Jin, P.; Wang, X. C.; Zhang, W.; An, W.; Wang, Y. Application of a hybrid gravity-driven membrane filtration and dissolved ozone flotation (MDOF) process for wastewater reclamation and membrane fouling mitigation. Journal of Environmental Sciences 2019, 81, 17-27
(127) Ibn Abdul Hamid, K.; Sanciolo, P.; Gray, S.; Duke, M.; Muthukumaran, S. Comparison of the effects of ozone, biological activated carbon (BAC) filtration and combined ozone-BAC pre-treatments on the microfiltration of secondary effluent. Separation and Purification Technology 2019, 215, 308-316
(128) Sathya, U.; Keerthi; Nithya, M.; Balasubramanian, N. Evaluation of advanced oxidation processes (AOPs) integrated membrane bioreactor (MBR) for the real textile wastewater treatment. Journal of Environmental Management 2019, 246, 768-775
(129) He, Z.; Xia, D.; Huang, Y.; Tan, X.; He, C.; Hu, L.; He, H.; Zeng, J.; Xu, W.; Shu, D. 3D Mn02 hollow microspheres ozone-catalysis coupled with flat-plate membrane filtration for continuous removal of organic pollutants: Efficient heterogeneous catalytic system and membrane fouling control. Journal of Hazardous Materials 2018, 344, 1198-1208
(130) Yu, W.; Brown, M.; Graham, N. J. D. Prevention of PVDF ultrafiltration membrane fouling by coating MnO₂ nanoparticles with ozonation. Scientific Reports 2016, 6, 30144
(131) Zhu, H.; Han, Y.; Ma, W.; Han, H.; Ma, W. Removal of selected nitrogenous heterocyclic compounds in biologically pretreated coal gasification wastewater (BPCGW) using the catalytic ozonation process combined with the two-stage membrane bioreactor (MBR). Bioresource Technology 2017, 245, 786-793
(132) EPA, U. 3rd Draft Method 1633: Analysis of Per- and Polyfluoroalkyl Substances (PFAS) in Aqueous, Solid, Biosolids, and Tissue Samples by LC-MS/MS 2022.
(133) Kasprzyk-Hordern, B.; Ziółek, M.; Nawrocki, J. Catalytic ozonation and methods of enhancing molecular ozone reactions in water treatment. Applied Catalysis B: Environmental 2003, 46, 639-669
(134) Jiao, L.; Regalbuto, J. R. The synthesis of highly dispersed noble and base metals on silica via strong electrostatic adsorption: I. Amorphous silica. Journal of Catalysis 2008, 260, 329-341
(135) Goss, K.-U. The pKa Values of PFOA and Other Highly Fluorinated Carboxylic Acids. Environmental Science & Technology 2008, 42, 456-458
(136) Zhang, Y.; Moores, A.; Liu, J.; Ghoshal, S. New Insights into the Degradation Mechanism of Perfluorooctanoic Acid by Persulfate from Density Functional Theory and Experimental Data. Environmental Science & Technology 2019, 53, 8672-8681
(137) Ikhlaq, A.; Kasprzyk-Hordern, B. Catalytic ozonation of chlorinated VOCs on ZSM-5 zeolites and alumina: Formation of chlorides. Applied Catalysis B: Environmental 2017, 200, 274-282
(138) Liu, X.; Mäki-Arvela, P.; Aho, A.; Vajglova, Z.; Gun′ko, V. M.; Heinmaa, I.; Kumar, N.; Eränen, K.; Salmi, T.; Murzin, D. Y. Zeta Potential of Beta Zeolites: Influence of Structure, Acidity, pH, Temperature and Concentration. Molecules 2018, 23, 946
(139) Parks, G. A. The Isoelectric Points of Solid Oxides, Solid Hydroxides, and Aqueous Hydroxo Complex Systems. Chemical Reviews 1965, 65, 177-198
(140) Borggaard, O. K. Effect of Surface Area and Mineralogy of Iron Oxides on Their Surface Charge and Anion-Adsorption Properties. Clays and Clay Minerals 1983, 31, 230-232
(141) Schwertmann, U.; Taylor, R. M. Iron Oxides. In Minerals in Soil Environments, John Wiley & Sons, Ltd, 2018; pp 379-438.
(142) Deng, S.; Yu, Q.; Huang, J.; Yu, G. Removal of perfluorooctane sulfonate from wastewater by anion exchange resins: Effects of resin properties and solution chemistry. Water Research 2010, 44, 5188-5195
(143) Gao, Y.; Deng, S.; Du, Z.; Liu, K.; Yu, G. Adsorptive removal of emerging polyfluoroalky substances F-53B and PFOS by anion-exchange resin: A comparative study. Journal of Hazardous Materials 2017, 323, 550-557
(144) Wang, W.; Maimaiti, A.; Shi, H.; Wu, R.; Wang, R.; Li, Z.; Qi, D.; Yu, G.; Deng, S. Adsorption behavior and mechanism of emerging perfluoro-2-propoxypropanoic acid (GenX) on activated carbons and resins. Chemical Engineering Journal 2019, 364, 132-138
(145) Qi, F.; Xu, B.; Chen, Z.; Ma, J.; Sun, D.; Zhang, L.; Wu, F. Ozonation catalyzed by the raw bauxite for the degradation of 2,4,6-trichloroanisole in drinking water. Journal of Hazardous Materials 2009, 168, 246-252
(146) Ateia, M.; Arifuzzaman, M.; Pellizzeri, S.; Attia, M. F.; Tharayil, N.; Anker, J. N.; Karanfil, T. Cationic polymer for selective removal of GenX and short-chain PFAS from surface waters and wastewaters at ng/L levels. Water Research 2019, 163, 114874
(147) Wang, F.; Shih, K.; Leckie, J. O. Effect of humic acid on the sorption of perfluorooctane sulfonate (PFOS) and perfluorobutane sulfonate (PFBS) on boehmite. Chemosphere 2015, 118, 213-218
(148) Maimaiti, A.; Deng, S.; Meng, P.; Wang, W.; Wang, B.; Huang, J.; Wang, Y.; Yu, G. Competitive adsorption of perfluoroalkyl substances on anion exchange resins in simulated AFFF-impacted groundwater. Chemical Engineering Journal 2018, 348, 494-502
(149) Wang, F.; Lu, X.; Shih, K. M.; Wang, P.; Li, X. Removal of perfluoroalkyl sulfonates (PFAS) from aqueous solution using permanently confined micelle arrays (PCMAs). Separation and Purification Technology 2014, 138, 7-12
(150) Jíša, K.; Nováková, J.; Schwarze, M.; Vondrová, A.; Sklenák, S.; Sobalik, Z. Role of the Fe-zeolite structure and iron state in the N2O decomposition: Comparison of Fe-FER, Fe-BEA, and Fe-MFI catalysts. J. Catal. 2009, 262, 27-34
(151) Pérez-Ramírez, J. Active iron sites associated with the reaction mechanism of N₂O conversions over steam-activated FeMFI zeolites. J. Catal. 2004, 227, 512-522
(152) Otto, T.; Zones, S. I.; Iglesia, E. Synthetic strategies for the encapsulation of nanoparticles of Ni, Co, and Fe oxides within crystalline microporous aluminosilicates. Micropor. Mesopor. Mat. 2018, 270, 10-23
(153) Harris, J. W.; Cordon, M. J.; Di Iorio, J. R.; Vega-Vila, J. C.; Ribeiro, F. H.; Gounder, R. Titration and quantification of open and closed Lewis acid sites in Sn-Beta zeolites that catalyze glucose isomerization. Journal of Catalysis 2016, 335, 141-154
(154) Harris, J. W.; Liao, W.-C.; Di Iorio, J. R.; Henry, A. M.; Ong, T.-C.; Comas-Vives, A.; Copéret, C.; Gounder, R. Molecular Structure and Confining Environment of Sn Sites in Single-Site Chabazite Zeolites. Chemistry of Materials 2017, 29, 8824-8837
(155) Cordon, M. J.; Hall, J. N.; Harris, J. W.; Bates, J. S.; Hwang, S.-J.; Gounder, R. Deactivation of Sn-Beta zeolites caused by structural transformation of hydrophobic to hydrophilic micropores during aqueous-phase glucose isomerization. Catalysis Science & Technology 2019, 9, 1654-1668
(156) Vega-Vila, J. C.; Harris, J. W.; Gounder, R. Controlled insertion of tin atoms into zeolite framework vacancies and consequences for glucose isomerization catalysis. Journal of Catalysis 2016, 344, 108-120
(157) Gounder, R.; Davis, M. E. Beyond shape selective catalysis with zeolites: Hydrophobic void spaces in zeolites enable catalysis in liquid water. AIChE Journal 2013, 59, 3349-3358
(158) Bermejo-Deval, R.; Gounder, R.; Davis, M. E. Framework and Extraframework Tin Sites in Zeolite Beta React Glucose Differently. ACS Catalysis 2012, 2, 2705-2713
(159) Zapata, P. A.; Huang, Y.; Gonzalez-Borja, M. A.; Resasco, D. E. Silylated hydrophobic zeolites with enhanced tolerance to hot liquid water. Journal of Catalysis 2013, 308, 82-97
(160) Wang, X.; Zhou, M.; Meng, X.; Wang, L.; Huang, D. Effect of protein on PVDF ultrafiltration membrane fouling behavior under different pH conditions: interface adhesion force and XDLVO theory analysis. Frontiers of Environmental Science & Engineering 2016, 10, 12
(161) Ziel, R.; Haus, A.; Tulke, A. Quantification of the pore size distribution (porosity profiles) in microfiltration membranes by SEM, TEM and computer image analysis. Journal of Membrane Science 2008, 323, 241-246
(162) AlMarzooqi, F. A.; Bilad, M. R.; Mansoor, B.; Arafat, H. A. A comparative study of image analysis and porometry techniques for characterization of porous membranes. Journal of Materials Science 2016, 51, 2017-2032
(163) Wyart, Y.; Georges, G.; Deumié, C.; Amra, C.; Moulin, P. Membrane characterization by microscopic methods: Multiscale structure. Journal of Membrane Science 2008, 315, 82-92
(164) Trapasso, G.; Russo, F.; Galiano, F.; McElroy, C. R.; Sherwood, J.; Figoli, A.; Aricò, F. Dialkyl Carbonates as Green Solvents for Polyvinylidene Difluoride Membrane Preparation. ACS Sustainable Chemistry & Engineering 2023, 11, 3390-3404
(165) Russo, F.; Galiano, F.; Pedace, F.; Aricò, F.; Figoli, A. Dimethyl Isosorbide As a Green Solvent for Sustainable Ultrafiltration and Microfiltration Membrane Preparation. ACS Sustainable Chemistry & Engineering 2020, 8, 659-668
(166) Ali, I.; Bamaga, O. A.; Gzara, L.; Bassyouni, M.; Abdel-Aziz, M. H.; Soliman, M. F.; Drioli, E.; Albeirutty, M. Assessment of Blend PVDF Membranes, and the Effect of Polymer Concentration and Blend Composition. Membranes 2018, 8, 13
(167) Marino, T.; Galiano, F.; Molino, A.; Figoli, A. New frontiers in sustainable membrane preparation: Cyrene™ as green bioderived solvent. Journal of Membrane Science 2019, 580, 224-234
(168) Gopal, R.; Kaur, S.; Ma, Z.; Chan, C.; Ramakrishna, S.; Matsuura, T. Electrospun nanofibrous filtration membrane. Journal of Membrane Science 2006, 281, 581-586
(169) Byun, S.; Davies, S. H.; Alpatova, A. L.; Corneal, L. M.; Baumann, M. J.; Tarabara, V. V.; Masten, S. J. Mn oxide coated catalytic membranes for a hybrid ozonation-membrane filtration: Comparison of Ti, Fe and Mn oxide coated membranes for water quality. Water Research 2011, 45, 163-170
(170) Khare, R.; Liu, Z.; Han, Y.; Bhan, A. A mechanistic basis for the effect of aluminum content on ethene selectivity in methanol-to-hydrocarbons conversion on HZSM-5. J. Catal. 2017, 348, 300-305
(171) Noh, G.; Zones, S. I.; Iglesia, E. Isomer sieving and the selective formation of terminal methyl isomers in reactions of linear alkanes on one-dimensional zeolites. Journal of Catalysis 2019, 377, 255-270
(172) Sarazen, M. L.; Doskocil, E.; Iglesia, E. Effects of Void Environment and Acid Strength on Alkene Oligomerization Selectivity. ACS Catal. 2016, 7059-7070
(173) Kim, J.; Van der Bruggen, B. The use of nanoparticles in polymeric and ceramic membrane structures: Review of manufacturing procedures and performance improvement for water treatment. Environmental Pollution 2010, 158, 2335-2349
(174) Chen, R.; Zhang, K.; Wang, H.; Wang, X.-m.; Zhang, X.-h.; Huang, X. Incorporating catalytic ceramic membrane into the integrated process of in situ ozonation, membrane filtration and biological degradation: Enhanced performance and underlying mechanisms. Journal of Membrane Science 2022, 652, 120509
(175) Psaltou, S.; Zouboulis, A. Catalytic Ozonation and Membrane Contactors-A Review Concerning Fouling Occurrence and Pollutant Removal. Water 2020, 12,
(176) Coelho, L. L.; Scaratti, G.; Hissanaga, A. M.; Oechsler, B. F.; José, H. J.; Moreira, R. d. F. P. M. Modeling and fouling control in a hybrid membrane process using CuO-catalytic membrane coupled to ozone. Journal of Environmental Chemical Engineering 2021, 9, 106138
(177) Focus Features. Dark Waters. 2019.
(178) Kuntzleman, T. S.; Jacobson, E. C. Teaching Beer's Law and Absorption Spectrophotometry with a Smart Phone: A Substantially Simplified Protocol. J. Chem. Eng. 2016, 93, 1249-1252
(179) Ward, L. M.; Shah, R. M.; Schiffman, J. D.; Weinman, S. T. Nanopatterning Reduces Bacteria Fouling in Ultrafiltration. ACS ES&T Water 2022, 2, 1593-1601
(180) Ward, L. M.; Fickling, B. G.; Weinman, S. T. Effect of Nanopatterning on Concentration Polarization during Nanofiltration. Membranes 2021, 11, 961
(181) Modak, S.; Kasula, M.; Esfahani, M. R. Nanoplastics Removal from Water using Metal-Organic Framework: Investigation of Adsorption Mechanisms, Kinetics, and Effective Environmental Parameters. ACS Applied Engineering Materials 2023, 1, 744-755
(182) Kasula, M.; Le, T.; Thomsen, A.; Rabbani Esfahani, M. Silver metal organic frameworks and copper metal organic frameworks immobilized on graphene oxide for enhanced adsorption in water treatment. Chemical Engineering Journal 2022, 439, 135542

### REFERENCE LIST FOR EXAMPLE 2

(1) U.S. EPA. Technical Fact Sheet: Drinking Water Health Advisories for Four PFAS (PFOA, PFOS, GenX Chemicals, and PFBS), 2022.
(2) DeLuca, Nicole M., et al. Environ. Intl., 2021, 146, 106308
(3) Franke, V. et al. Environ. Sci.: Water Res. Technol. 2019, 5 (11), 1887-1896.
(4) Nawrocki, Jacek, and Barbara Kasprzyk-Hordern.” Applied Catalysis B: Environ., 2010, 99, 27-42.
(5) Otto, Trenton, et al. Microporous and Mesoporous Materials, 2018, 270, 10-13.
(6) Treacy, Michael, and John Higgins. Collection of Simulated XRD Powder Patterns for Zeolites, 2001.

What is claimed is:

1. A method for chemically degrading per- and polyfluorinated substances (PFAS), comprising contacting a metal oxide encapsulated in a zeolite with an aqueous PFAS and ozone.

2. The method of claim 1, wherein the metal oxide comprises Fe₂O₃, CuO, MnO₂, TiO₂, ZnO, CeO₂, V₂O₅ or any combination thereof.

3. The method of claim 1, wherein the zeolite has a pore diameter of from about 0.05 nm to about 1 nm.

4. The method of claim 1, wherein the aqueous PFAS has a concentration of from about 10 ppm to about 5000 ppm; and
wherein contacting the metal oxide encapsulated in the zeolite with the aqueous PFAS and ozone occurs for from about 1 hour to about 48 hours.

5. The method of claim 1, further comprising heating the aqueous PFAS to a temperature of from about 50° C. to about 100° C.

6. A method for chemically degrading PFAS, comprising contacting a membrane with PFAS and ozone, wherein the membrane is doped with a metal oxide.

7. The method of claim 6, wherein the metal oxide comprises Fe₂O₃, CuO, MnO₂, TiO₂, ZnO, CeO₂, V₂O₅ or any combination thereof.

8. The method of claim 6, wherein the metal oxide has a concentration of from about 0.1 wt % to about 5 wt % in the membrane.

9. The method of claim 6, wherein the aqueous PFAS has a concentration of from about 10 ppm to about 5000 ppm; and
wherein contacting the membrane with PFAS and ozone occurs for from about 1 hour to about 48 hours.

10. The method of claim 6, further comprising heating the aqueous PFAS to a temperature of from about 50° C. to about 100° C.

11. A composition for chemical degradation of PFAS, comprising a membrane doped with a metal oxide encapsulated in a zeolite.

12. The composition of claim 11, wherein both the membrane and the zeolite are hydrophobic.

13. The composition of claim 11, wherein the membrane comprises polyvinylidene fluoride (PVDF), polytetrafluoroethylene (PTFE), polyethylene (PE), polypropylene (PP) polysulfone (PSF), polyethersulfone (PES), polyacrylonitrile (PAN), cellulose acetate (CA), or any combination thereof.

14. The composition of claim 11, wherein the metal oxide comprises Fe₂O₃, CuO, MnO₂, TiO₂, ZnO, CeO₂, V₂O₅ or any combination thereof.

15. The composition of claim 11, wherein the zeolite comprises a Beta zeolite, an MFI zeolite, an LTA zeolite, an FAU zeolite, an MOR zeolite, an FER zeolite, a CHA zeolite, a mesoporous material (e.g., SBA-15 or MCM-41), or any combination thereof.

16. The composition of claim 11, wherein the zeolite has a pore diameter of from about 0.05 nm to about 1 nm.

17. The composition of claim 11, wherein the metal oxide encapsulated in the zeolite has a concentration of from about 0.1 wt % to about 5 wt % in the membrane.

18. A method for chemically degrading PFAS, comprising contacting the composition of claim 11 with aqueous PFAS and ozone.

19. The method of claim 18, wherein the aqueous PFAS has a concentration of from about 10 ppm to about 5000 ppm; and
wherein contacting the membrane with the composition occurs for from about 1 hour to about 48 hours.

20. The method of claim 18, further comprising heating the aqueous PFAS to a temperature of from about 50° C. to about 100° C.
